(19) United States
(12) Patent Application Publication
(10) Pub. No.: US 2023/0316658 A1
(43) Pub. Date: Oct. 5, 2023

(54) Shared Space Boundaries and Phantom Surfaces

(71) Applicant: Apple Inc., Cupertino, CA (US)

(72) Inventors: Connor A. Smith, San Mateo, CA (US); Nicholas W. Henderson, San Carlos, CA (US); Luis R. Deliz Centeno, Oakland, CA (US); Bruno M. Sommer, Sunnyvale, CA (US); Timofey Grechkin, Sunnyvale, CA (US)

(21) Appl. No.: 18/182,173

(22) Filed: Mar. 10, 2023

Related U.S. Application Data
(63) Continuation of application No. PCT/US2021/049590, filed on Sep. 9, 2021.
(60) Provisional application No. 63/076,667, filed on Sep. 10, 2020.
(60) Provisional application No. 63/175,077, filed on Apr. 15, 2021.
(60) Provisional application No. 63/234,549, filed on Aug. 18, 2021.

(51) Int. Cl. G06T 19/00; G06F 3/01

(52) U.S. Cl. CPC G06T 19/00; G06F 3/011; G06T 2219/024; G06T 2210/21; H04L 67/131

(57) ABSTRACT

Presentation of objects within the multiuser communication session is changed based on a shared or unshared status, or whether a user is interacting with the object. The movement of a user of a first device is monitored within a first physical environment comprising shared objects and unshared objects, where the shared objects are visible to the user and an additional user of a second device in a second physical environment, the first device and the second device are active in a multiuser communication session, and the unshared objects are visible to the user and are not visible to the additional user. An interaction of the user with an unshared object is detected. In accordance with the detection of the interaction of the user with the unshared object, a representation of at least a portion of the unshared object is provided for presentation by the second device.

### BACKGROUND

This disclosure relates generally to image processing. More particularly, but not by way of limitation, this disclosure relates to techniques and systems for providing tools to enhance multiuser communication in a multiuser communication session within an extended reality environment.

Some devices are capable of generating and presenting extended reality (XR) environments. An XR environment may include a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. Some XR environments allow multiple users to interact with each other within the XR environment. However, what is needed is an improved technique to provide spaces for presentation of a multiuser communication session.

### BRIEF DESCRIPTION OF THE DRAWINGS

FIG. 1 shows, in block diagram form, a simplified system diagram according to one or more embodiments.

FIG. 2 shows a diagram of example operating environments, according to one or more embodiments.

FIG. 3 depicts a flowchart of a technique for presenting a representation of the multiuser communication session within a usable geometry, according to one or more embodiments.

FIG. 4 shows a flowchart of a technique for presenting a representation of a multiuser communication session based on movement of a remote user, according to one or more embodiments.

FIG. 5 shows an example display of a representation of a multiuser communication session, according to one or more embodiments.

FIG. 6 shows an example display of a representation of a multiuser communication session when a user leaves a usable geometry, according to one or more embodiments.

FIG. 7 shows an example flow diagram for presenting representations of phantom surfaces in a multiuser communication session, according to one or more embodiments.

FIGS. 8A-8B show example system diagrams of displays in which a representation of phantom surfaces are presented, according to one or more embodiments.

FIG. 9 shows an example flowchart of a technique for updating a location of a shared space location in accordance with one or more embodiments.

FIG. 10 shows an example flowchart of a technique for updating a presentation of a shared space container in accordance with one or more embodiments.

FIG. 11 depicts an example of shared space containers in different physical environments, in accordance with one or more embodiments.

FIGS. 12A-12B depict examples of shared space containers in different environments based on an updated shared space container location, in accordance with one or more embodiments.

FIG. 13A and FIG. 13B depict an example of a presentation of an unshared object in a multiuser communication session, according to one or more embodiments.

FIG. 14 illustrates a flowchart of a technique for presenting shared and unshared virtual objects within a multiuser communication session, in accordance with one or more embodiments.

FIGS. 15A-15C depict an example of a presentation in a first physical environment of a representation of a physical object in a second physical environment, in accordance with one or more embodiments.

FIG. 16 depicts a flowchart of a technique for generating a representation of a physical object in a multiuser communication session, in accordance with one or more embodiments.

FIGS. 17A-17C depict example views of physical environments in which a multiuser communication session is active. In particular, FIGS. 17A-C depict an example of a movement of a shared virtual object by one user in a multiuser communication session.

FIG. 18 depicts a flowchart of a technique for movement of a shared virtual object in a multiuser communication session, in accordance with one or more embodiments.

FIGS. 19A-19B show exemplary systems for use in various computer simulated extended reality technologies.

### DETAILED DESCRIPTION

This disclosure pertains to systems, methods, and computer readable media to provide enhancements for presenting components of a multiuser communication session in a manner that is consistent to users within the session. In some embodiments, the techniques described herein provide a method for determining a common usable geometry for users active in a multiuser communication session such that components of the multiuser communication session may be placed within the usable geometry. In one or more embodiments, characteristics of the physical environment of each of the users active in the multiuser communication session may be obtained in order to determine a size or dimensions of a region that is available in each space. In some embodiments, the usable geometry may be determined based on the physical environment of each user in the multiuser communication session, or a subset of users active in the multiuser communication session.

Components of the multiuser communication session may be placed in the usable geometry for each device in such a manner that the components appear consistent in each device's representation of the multiuser communication session. For example, a reference point may be utilized in the usable geometry which may define a placement of various components of the multiuser communication session. As another example, common coordinate may be utilized to determine consistent placement of components of the multiuser communication session for the various devices. In some embodiments, the boundaries of the usable geometry may be visible or not visible in the representation of the multiuser communication session. That is, boundaries of the geometry may or may not be presented to a user.

In some embodiments, the usable geometry may determine how a user or components are presented if a user leaves the usable geometry. For example, in some embodiments, if a local user walks outside of a usable geometry in a local representation of the multiuser communication session, the contents of the multiuser communication session may no longer be visible to the local user. In some embodiments, the representation of the boundary of the usable geometry may be visible to the local user. Further, the representation of the local user may no longer be visible to remote users. However, in some embodiments, audio for the local user may be provided to the remote users, or a visual representation on the boundary of the usable geometry may indicate a user's presence external to the usable geometry. In some embodiments, the audio of the local user or the placement of the representation on the boundary may indicate a relative location of the local user outside the usable geometry.

According to some embodiments, a user may utilize the physical space in a local environment that has physical objects, such as furnishings and the like, which may not be visible to remote users, but which may impact movements of the local user. According to some embodiments, a local device may detect or otherwise receive an indication that the user's movement is affected by a physical object in a physical environment. The device may transmit an indication of the physical object to one or more remote users in the multiuser communication session such that the remote representations of the multiuser communication session may include contextual information, such as phantom surfaces (e.g., a virtual representation of a surface), which may provide context for the user's movement. According to some embodiments, the indication may include image data of the physical objects, the geometry of the physical objects, or the like. In some embodiments, a level of detail of the physical object may be determined according to a privacy policy. For example, physical objects that contain personal identifying information may be more obscured to remote users than generic objects. Further, in some embodiments, a level of detail regarding the physical object may depend on the remote user's relationship to the local user. For example, a local user having a sufficiently close relationship may be associated with lower security standards such that more detail about the local user's physical environment may be provided to the remote user. Alternatively, if the local user and remote user are merely acquaintances, a lower level of detail may be provided to the remote user.

A person can interact with and/or sense a physical environment or physical world without the aid of an electronic device. A physical environment can include physical features, such as a physical object or surface. An example of a physical environment is physical forest that includes physical plants and animals. A person can directly sense and/or interact with a physical environment through various means, such as hearing, sight, taste, touch, and smell. In contrast, a person can use an electronic device to interact with and/or sense an extended reality (XR) environment that is wholly or partially simulated. The XR environment can include mixed reality (MR) content, augmented reality (AR) content, virtual reality (VR) content, and/or the like. With an XR system, some of a person's physical motions, or representations thereof, can be tracked and, in response, characteristics of virtual objects simulated in the XR environment can be adjusted in a manner that complies with at least one law of physics. For instance, the XR system can detect the movement of a user's head and adjust graphical content and auditory content presented to the user similar to how such views and sounds would change in a physical environment. In another example, the XR system can detect movement of an electronic device that presents the XR environment (e.g., a mobile phone, tablet, laptop, or the like) and adjust graphical content and auditory content presented to the user similar to how such views and sounds would change in a physical environment. In some situations, the XR system can adjust characteristic(s) of graphical content in response to other inputs, such as a representation of a physical motion (e.g., a vocal command).

Many different types of electronic systems can enable a user to interact with and/or sense an XR environment. A non-exclusive list of examples include heads-up displays (HUDs), head mountable systems, projection-based systems, windows or vehicle windshields having integrated display capability, displays formed as lenses to be placed on users' eyes (e.g., contact lenses), headphones/earphones, input systems with or without haptic feedback (e.g., wearable or handheld controllers), speaker arrays, smartphones, tablets, and desktop/laptop computers. A head mountable system can have one or more speaker(s) and an opaque display. Other head mountable systems can be configured to accept an opaque external display (e.g., a smartphone). The head mountable system can include one or more image sensors to capture images/video of the physical environment and/or one or more microphones to capture audio of the physical environment. A head mountable system may have a transparent or translucent display, rather than an opaque display. The transparent or translucent display can have a medium through which light is directed to a user's eyes. The display may utilize various display technologies, such as ULEDs, OLEDs, LEDs, liquid crystal on silicon, laser scanning light source, digital light projection, or combinations thereof. An optical waveguide, an optical reflector, a hologram medium, an optical combiner, combinations thereof, or other similar technologies can be used for the medium. In some implementations, the transparent or translucent display can be selectively controlled to become opaque. Projection-based systems can utilize retinal projection technology that projects images onto users' retinas. Projection systems can also project virtual objects into the physical environment (e.g., as a hologram or onto a physical surface).

For purposes of this disclosure, a multiuser communication session can include an XR environment in which two or more devices are participating.

For purposes of this disclosure, a local multiuser communication device refers to a current device being described, or being controlled by a user being described, in a multiuser communication session.

For purposes of this disclosure, colocated multiuser communication devices refer to two or more devices that share a physical environment and an XR environment, such that the users of the colocated devices may experience the same physical objects and XR objects.

For purposes of this disclosure, a remote multiuser communication device refers to a secondary device that is located in a separate physical environment from a current, local multiuser communication device. In one or more embodiments, the remote multiuser communication device may be a participant in the XR environment.

For purposes of this disclosure, shared virtual elements refer to XR objects that are visible or otherwise able to be experienced by participants in a common XR environment.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. I t should be understood however that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developers' specific goals (e.g., compliance with system- and business-related constraints), and that these goals may vary from one implementation to another. It will also be appreciated that such development efforts might be complex and time-consuming, but would nevertheless be a routine undertaking for those of ordinary skill in the design and implementation of graphics modeling systems having the benefit of this disclosure.

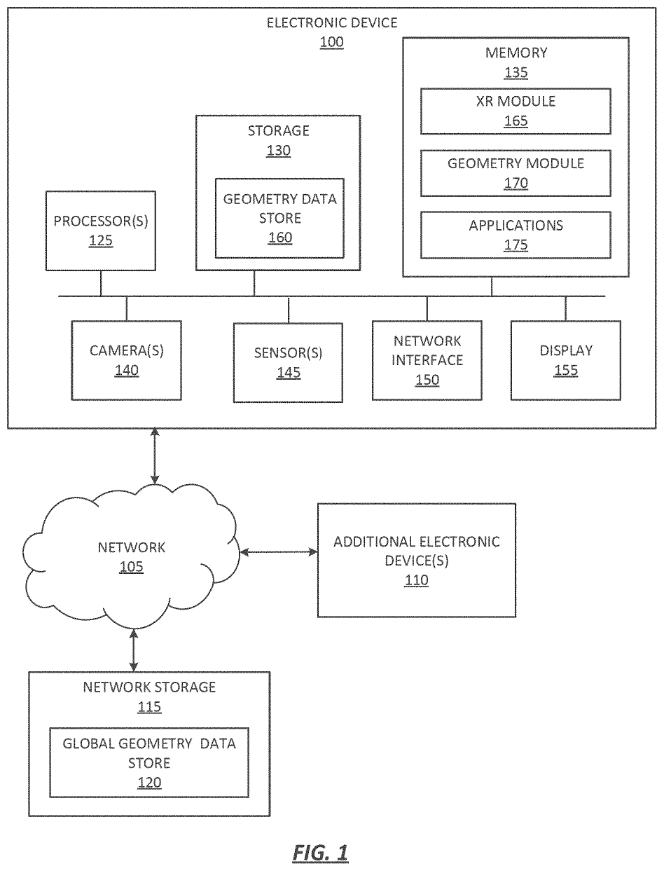

Referring to FIG. 1, a simplified block diagram of an electronic device 100 is depicted, communicably connected to additional electronic devices 110 and a network storage 115 over a network 105, in accordance with one or more embodiments of the disclosure. Electronic device 100 may be part of a multifunctional device, such as a mobile phone, tablet computer, personal digital assistant, portable music/video player, wearable device, head-mounted systems, projection-based systems, base station, laptop computer, desktop computer, network device, or any other electronic systems such as those described herein. Electronic device 100, additional electronic device 110, and/or network storage 115 may additionally, or alternatively, include one or more additional devices within which the various functionality may be contained, or across which the various functionality may be distributed, such as server devices, base stations, accessory devices, and the like. Illustrative networks, such as network 105 include, but are not limited to, a local network such as a universal serial bus (USB) network, an organization's local area network, and a wide area network such as the Internet. According to one or more embodiments, electronic device 100 is utilized to participate in a multiuser communication session in an XR environment. It should be understood that the various components and functionality within electronic device 100, additional electronic device 110 and network storage 115 may be differently distributed across the devices, or may be distributed across additional devices.

Electronic Device 100 may include one or more processors 125, such as a central processing unit (CPU). Processor(s) 125 may include a system-on-chip such as those found in mobile devices and include one or more dedicated graphics processing units (GPUs). Further, processor(s) 125 may include multiple processors of the same or different type. Electronic device 100 may also include a memory 135. Memory 135 may include one or more different types of memory, which may be used for performing device functions in conjunction with processor(s) 125. For example, memory 135 may include cache, ROM, RAM, or any kind of transitory or non-transitory computer readable storage medium capable of storing computer readable code. Memory 135 may store various programming modules for execution by processor(s) 125, including XR module 165, geometry module 170, and other various applications 175. Electronic device 100 may also include storage 130. Storage 130 may include one more non-transitory computer-readable mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Storage 130 may be configured to store a geometry data store 160, according to one or more embodiments. Electronic device may additionally include a network interface 150 from which the electronic device 100 can communicate across network 105.

Electronic device 100 may also include one or more cameras 140 or other sensors 145, such as depth sensor(s), from which depth or other characteristics of an environment may be determined. In one or more embodiments, each of the one or more cameras 140 may be a traditional RGB camera, or a depth camera. Further, cameras 140 may include a stereo- or other multi-camera system, a time-of-flight camera system, or the like. Electronic device 100 may also include a display 155. The display device 155 may utilize digital light projection, OLEDs, LEDs, ULEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Storage 130 may be utilized to store various data and structures which may be utilized for providing state information in order to manage geometry data for physical environments of a local user and/or a remote user. Storage 130 may include, for example, geometry data store 160. Geometry data store 160 may be utilized to store data related to one or more physical environments in which electronic device 100 participates in a multiuser communication session. For example, geometry data store 160 may store characteristics of a physical environment which may affect available space for presentation of components of a multiuser communication session. As another example, geometry data store 160 may store characteristics of a physical environment which may affect how a local user moves around the space, or interacts within the space. Additionally, or alternatively, geometry data may be stored across network 105, such as by global geometry data store 120.

According to one or more embodiments, memory 135 may include one or more modules that comprise computer readable code executable by the processor(s) 125 to perform functions. The memory may include, for example, an XR module 165 which may be used to provide a representation of a multiuser communication session in an XR environment. The multiuser communication session XR environment may be a computing environment which supports a shared experience by electronic device 100 as well as additional electronic devices 110.

The memory 135 may also include a geometry module 170, which manages geometric characteristics of a user's physical environment which may affect how a representation of a multiuser communication session is presented, such as by XR module 165. The geometry module 170 may determine geometric characteristics of a physical space, for example from sensor data collected by sensor(s) 145, or from pre-stored information, such as from geometry data store 160. Applications 175 may include, for example, computer applications that may be experienced in an XR environment by multiple devices, such as electronic device 100 and additional electronic devices 110.

Although electronic device 100 is depicted as comprising the numerous components described above, in one or more embodiments, the various components may be distributed across multiple devices. Accordingly, although certain calls and transmissions are described herein, with respect to the particular systems as depicted, in one or more embodiments, the various calls and transmissions may be made differently directed based on the differently distributed functionality. Further, additional components may be used, some combination of the functionality of any of the components may be combined.

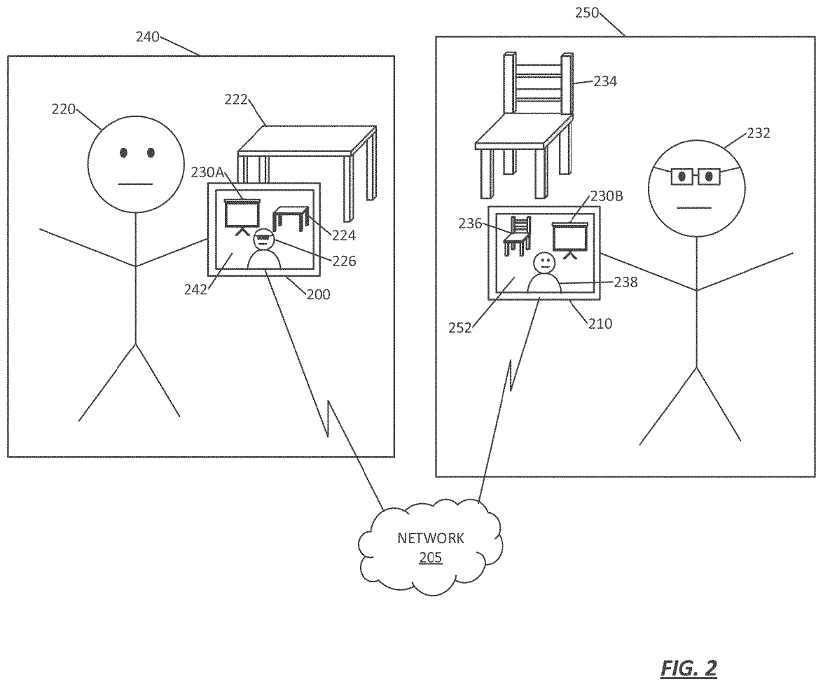

FIG. 2 shows a diagram of example operating environments, according to one or more embodiments. While pertinent features are shown, those of ordinary skill in the art will appreciate, from the present disclosure, that various other features have not been illustrated for the sake of brevity and so as not to obscure more pertinent aspects of the example among implementations disclosed herein. To that end, as a nonlimiting example, the operating environment 240 includes a first physical environment, whereas operating environment 250 includes a second physical environment.

As shown in FIG. 2, the first environment 240 includes a first user 220 that is utilizing a first electronic device 200, and the second environment 250 includes a second user 232 that is utilizing a second electronic device 210. In one or more embodiments, the first electronic device 200 and the second electronic device 210 include mobile devices, such as handheld devices, wearable devices, and the like.

In one or more embodiments, the first electronic device 200 and the second electronic device 210 communicate with each other via a network 205. Examples of network 205 may include, for example, the Internet, a wide area network (WAN), a local area network (LAN), etc. In one or more embodiments, the first electronic device 200 and the second electronic device 210 may be participating in a common multiuser communication session.

Although electronic device 200 and electronic device 210 may be participating in a common multiuser communication session, the shared virtual objects may be rendered differently on each device. As shown, the electronic device 200 may depict physical objects of the environment 240. As shown, physical table 222 may be depicted on the display 242 as a virtual table 224. In one or more embodiments, the display 242 may be a see-through display, and virtual table 224 may simply be a view of physical table 222 through display 242.

Display 242 of electronic device 200 may also include an avatar 226 corresponding to user 232. For purposes of this disclosure, and avatar may include a virtual representation of a user. The avatar may depict real-time actions of the corresponding user 232, including movement, updated location, and/or interactions with various physical components and/or virtual components within the XR environment. An avatar may or may not mimic physical characteristics of the user, and may or may not mimic facial expressions of the user.

According to one or more embodiments, a multiuser communication session may support one or more multiuser applications or other modules which allow for depictions of shared virtual objects across multiple participating devices, such as electronic device 200 and electronic device 210. As shown in display 242, presentation panel 230A is an example of a virtual object which may be visible to all participating devices.

As an example, returning to environment 250, electronic device 210 includes a display 252, on which the presentation panel virtual object 230B is depicted. It should be understood that in one or more embodiments, although the same virtual object may be visible across all participating devices, the virtual object may be rendered differently according to the location of the electronic device, the orientation of the electronic device, or other physical or virtual characteristics associated with electronic devices 200 and 210 and/or the representation of the multiuser communication session depicted within displays 242 and 252.

Returning to environment 250, a physical chair 234 is depicted as virtual chair 236. As described above, and one or more embodiments, display 252 may be a see-through display, and virtual chair 236 may be a view of physical chair 234 through the see-through display 252. In addition, electronic device 210 depicts an avatar 238 corresponding to user 220 within physical environment 240. Another characteristic of a multiuser communication session XR environment is that while virtual objects may be shared across participating devices, physical worlds may appear different. As such, the representations of the multiuser communication session may differ across devices. For instance, the XR environment depicted in display 242 includes presentation panel 230A that also appears in the XR environment depicted in display 252. However, the XR environment depicted in display 242 includes representation 224 of physical table 222, which is not included in the XR environment depicted in display 252. Similarly, the XR environment depicted in display 252 includes representation 236 of physical chair 234, which is not included in the XR environment depicted in display 242.

According to one or more embodiments, the virtual objects, such as presentation panel 230, may be rendered as part of an application. In one or more embodiments, multiple applications may be executed within the XR environments depicted in 242 and 252.

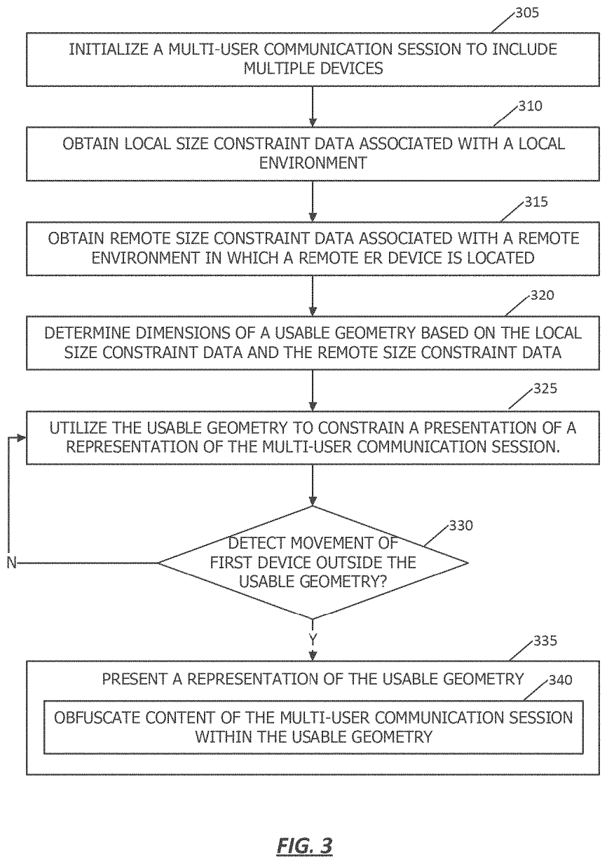

FIG. 3 depicts a flowchart of a technique for presenting a representation of the multiuser communication session within a usable geometry determined based on space constraints of physical environments of the users active in the multiuser communication session. For purposes of explanation, the flowchart is described utilizing example components from FIG. 1. Although the flowchart shows various procedures performed by particular components in a particular order, it should be understood that according to one or more embodiments, the various processes may be performed by alternative devices or modules. In addition, the various processes may be performed in an alternative order, and various combinations of the processes may be performed simultaneously. Further, according to some embodiments, one or more of the processes may be omitted, or others may be added.

The flowchart begins at block 305, where the XR module 165 initializes a multiuser communication session to include multiple devices. The multiuser communication session may include various components, such as shared virtual objects, representations of remote users, interactive applications, and the like, which are shared among users in the multiuser communication session.

The flowchart continues at block 310, where the geometry module 170 obtains a local size constraint data associated with the local environment. According to one or more embodiments, the local size constraint data may be associated with a local geometry, such as a volume or area, which is available for presentation of a representation of the multiuser communication session. For example, the usable geometry may not be greater than the physical size of a room in which the local user is located in order to prevent the components of the multiuser communication session to intersect or be hidden behind physical walls, furnishings, and the like. In one or more embodiments, the local size constraint may be associated with two-dimensional or three-dimensional dimensions in which components of the multiuser communication session may be presented. In one or more embodiments, the local size constraint data may additionally be determined based on user preference or other factors. As an example, a user may provide a user preference of a particular portion of the physical environment which should be utilized for presentation of the representation of a multiuser communication session. As another example, the local size constraint data may be associated with one or more application types initialized as part of the multiuser communication session. For example, if the multiuser communication session includes media presentation, the geometry module 170 may identify size constraint data that includes a blank wall or other physical structure which may be preferable to present the media presentation application. As another example, if a tabletop type application is initiated, then the shared geometry may include a surface in the physical environment onto which the application may be presented. The local size constraint data may be determined in a number of ways. For example, the local device may scan the room to determine geometric properties of the physical environment. As another example, a particular physical environment may be prestored and geometry data store 160 or global geometry data store 120.

At block 315, the geometry module 170 obtains remote size constraint data associated with the remote environment in which the remote device is located. In one or more embodiments, the geometry module 170 obtains the remote size constraint data for each remote device active in the multiuser communication session. Similarly, when a new remote device joins the multiuser communication session the local device may additionally receive the constraint data to make an updated determination. The remote size constraint data may include two-dimensional or three-dimensional dimensions for an area or volume of the of the remote physical environment in which the remote device is located, which is available for presentation of the representation of the multiuser communication session. The remote size constraint data may be provided by the remote device. For example, the remote device may scan the remote physical environment, or may receive scan information about the remote physical environment. In some embodiments, the remote device may have prestored geometry data for the remote physical environment. As another example, the local device for the remote device may obtain the remote constraint data from a global geometry data store 120.

The flowchart continues at block 320, where the geometry module 170 determines dimensions of a usable geometry based on the local size constraint data and the remote size constraint data. In one or more embodiments, the geometry module determines the dimensions based on an intersection between the local constraint and the remote constraint. In one or more embodiments, the dimensions may be two-dimensional or three-dimensional dimensions which should be utilized by each device in the multiuser communication session for presentation of components of the session. In some embodiments, additional data may be utilized to determine the dimensions of the usable geometry. For example, if one remote device has a space that is smaller than a threshold area or volume required by one or more applications of the multiuser communication session, that user's remote size constraint data may be discarded or otherwise given lesser weight when determining the usable geometry. In one or more embodiments, if no common usable geometry may be determined, a predefined usable geometry may be utilized. In one or more embodiments, the predetermined usable geometry may be based on applications running in the multiuser communication session, user specific data for the users active in the multi community multiuser communication session, or the like. In some embodiments, local size constraint data and remote size constraint data are transmitted to, or otherwise obtained by, a server. As such, the dimensions of the usable geometry may be determined remotely at a server having access to the local size constraint data and remote size constraint data.

The flowchart continues at block 325, where the XR module 165 utilizes the usable geometry to constrain a presentation of a representation of the multiuser communication session. In some embodiments, the XR module 165 uses the usable geometry to determine placement of shared virtual objects for presentation. For example, if the multiuser communication session includes a set of shared virtual objects, the XR module 165 will utilized the usable geometry to arrange presentation of the shared virtual objects.

At block 330, a determination is made as to whether movement of the first device is detected outside the usable geometry. If a movement is detected and it is not outside the usable geometry, then the flowchart returns to block 325, and the XR module 165 continues to utilize the usable geometry to constrain the presentation of the representation of the multiuser communication session. Accordingly, a user may move around the usable geometry in the local physical environment during the multiuser communication session.

If at block 330, it is determined that the movement of the local device is outside the usable geometry, then the flowchart continues to block 335. At block 335, the XR module 165 presents a representation of the usable geometry. That is, the local user may be standing outside the usable geometry, and thus the area in which the multiuser communication session is presented. In some embodiments, when the local user is outside the usable geometry, a presentation of the representation of the usable geometry is provided. For example, a shaded region may indicate where the bounds of the usable geometry such that the local user can move back into the usable geometry.

According to some embodiments, when a user is outside the usable geometry, it may be preferable for components of the multiuser communication session to be hidden from the local user. As such, at block 340, in some embodiments, content of the multiuser communication session is obfuscated from the local user when the local user steps outside or otherwise leaves the usable geometry. For example, privacy settings may indicate that only the remote users active within the usable geometry can view components within the usable geometry. According to some embodiments, audio information may also be modified when a user leaves the usable geometry. In some embodiments, when a user leaves the usable geometry, audio from multiuser communication session may no longer be presented to the user. Additionally, or alternatively, audio from the user may be omitted from the multiuser communication session. In some embodiments, audio from the user may continue if the user is outside the usable geometry. A visual representation of the user outside the usable geometry may not be visible to other users in the multiuser communication session, but audio information, such as the user's voice, may be presented to other users in the multiuser communication session. In some embodiments, the user's voice or other audio associated with the user may be presented to be projected from a boudary of the usable geometry nearest to the user.

In some embodiments, a representation of the usable geometry may be presented if the user is within a predetermined distance of a boundary of the geometry. For example, the user may be inside the usable geometry but within a predetermined distance. The representation of the geometry may indicate to the user a boundary of the usable geometry in which the representation of the multiuser communication session is presented for all users. In some embodiments, the representation of the usable geometry may be a shaded plane or other indication of a boundary of the usable geometry.

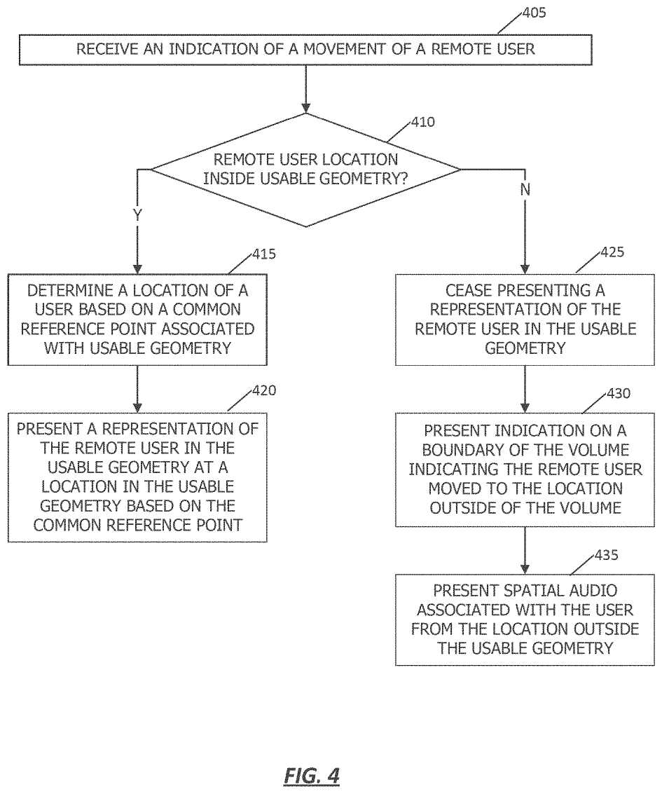

FIG. 4 depicts a flowchart of various ways of representing a remote user moving around a remote physical environment. For purposes of explanation, the flowchart is described utilizing example components from FIG. 1. Although the flowchart shows various procedures performed by particular components in a particular order, it should be understood that according to one or more embodiments, the various processes may be performed by alternative devices or modules. In addition, the various processes may be performed in an alternative order, and various combinations of the processes may be performed simultaneously. Further, according to some embodiments, one or more of the processes may be omitted, or others may be added.

The flowchart begins at block 405, where the local device receives an indication of the movement of the remote user. The movement may be received, for example, based on sensor data of the remote device, location data of the remote device, and the like. The movement of the remote user may include, for example, a route of the user, an updated final destination after the user's movement, and the like.

The flowchart continues at block 410, where determination is made regarding whether the remote user's location is inside the usable geometry. According to one or more embodiments, the usable geometry may be associated with a reference point by which components of the multiuser communication session are identified. For example, the reference point may provide a reference as to where to present components within the usable geometry. As such, the bounds of usable geometry may be identified based on the reference point.

If it is determined at block 410 that the remote user has moved to a new location within the usable geometry, then the flowchart continues to block 415, where the geometry module determines the location of the user based on a common reference point associated with usable geometry. As an example, the local device may receive a spatial relationship between the new location of the remote user and the reference point in the remote user's representation of the multiuser communication session. The local device may translate the spatial relationship to the local presentation of the multiuser communication session to identify a location in the local representation of the multiuser communication session at which the remote user should be placed. The flowchart continues to block 420, where the XR module 165 presents a representation of the remote user at the location in the usable geometry based on the common reference point.

Returning to block 410, if a determination is made that the remote user's location is not inside usable geometry, then the flowchart continues to block 425. At block 425, the XR module 165 ceases presenting the representation of the remote user in the usable geometry. In some embodiments, the flowchart continues to block 430, where the XR module 165 presents an indication on the boundary of the volume or usable geometry indicating the remote user moved to the location outside of the usable geometry. As an example, the indication may be a shaded area, a wall or plane representing a boundary of the usable geometry, or other visual representation corresponding to the location of the user outside the geometry. As such, the visual indication may indicate that a remote user is active within the multiuser communication session, but is not currently located within the usable geometry in which components of the multiuser communication session are presented. In one or more embodiments, the visual indication may indicate a relative location outside the usable geometry at which the remote user is located. For example, a vector may be determined from the local user to an area behind the usable geometry at which the remote user is located in the XR environment or local physical environment. The intersection of the vector with the bounds of the usable geometry may be used as the location of the visual representation of the remote user. In one or more embodiments, the visual presentation may move along with the remote user such that a relative location of the remote user outside the usable geometry is indicated by the visual indication.

The flowchart concludes at block 435, where spatial audio is presented in association with the remote user from the location outside a usable geometry. For example, the audio associated with the remote user can be spatialized from the location of the remote user outside the usable geometry. As such, the remote user may continue to speak or provide other audio content which will appear from the location outside the usable geometry even while the remote user is not visible within the usable geometry.

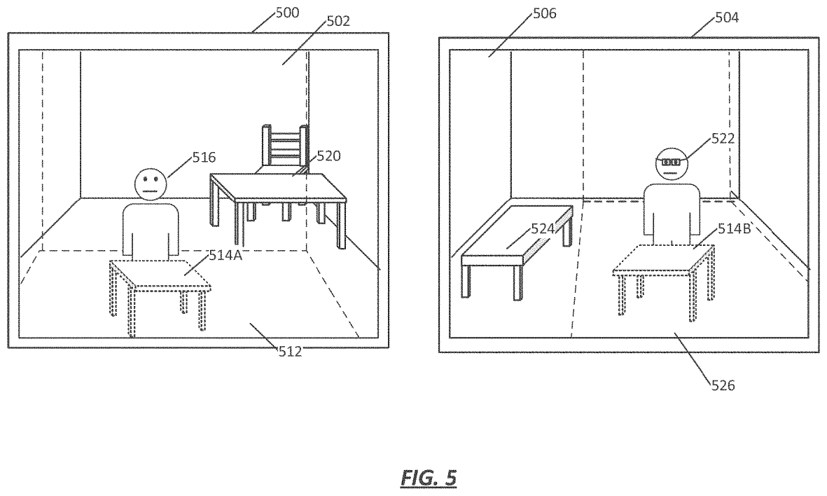

FIG. 5 shows an example user interface for selecting and utilizing a tool. The example display is merely for explanation purposes, and is not intended to limit the disclosure.

Device 500 depicts a display of the physical environment 502, for example through a pass-through display or semi-transparent display. Physical environment 502 is associated with a physical environment of a first user and includes a display or view of physical objects as well as extended reality objects. For example, desk 520 may be a physical desk in physical environment 502 which is either presented on the display of device 500, or is viewable through the pass-through display of device 500.

Device 500 also includes a usable geometry 512. While the bounds of usable geometry 512 are depicted in the display of device 500, it should be understood that in one or more embodiments, the bounds of usable geometry may not be displayed. According to some embodiments, the bounds of the usable geometry may be associated with an area or volume within the physical environment 502 which is available for presentation of components of the multiuser communication session. As such, usable geometry 512 includes virtual object 514A, which is a virtual table, as well as avatar 516, which is a representation of the second user of the multiuser communication session. Avatar 516 is associated with the user in a separate physical environment utilizing the multiuser communication session from the second device.

Device 504 depicts the second device also active in the same multiuser communication session as the first device 500. Device 504 may be utilized by a second user, such as the user associated with avatar 516. As such, the display of device 504 includes physical objects as well as extended reality objects and other components of the multiuser communication session. As such, 506 includes a physical environment with physical components, such as bench 524. As described above, the display of device 504 may be a display which presents image data, for example from a front facing camera, which collects image data of the local environment. As such, bench 524 may be image data of a physical bench in the local physical environment. Alternatively, the display of device 504 may be a pass-through display, and bench 524 may be a physical bench that is visible through the pass-through display.

Device 504 includes a usable geometry 526, in which components of the multiuser communication session may be presented. As described above, the dimensions of usable geometry 512 and usable geometry 526 may be the same, or otherwise related to each other. For example, the second user may have a larger available space than a first user, but the usable geometry 526 is constrained by the available physical space in the first user's physical environment 502. According to one or more embodiments, the usable geometry 526 includes the components of the multiuser communication session, including the shared components such as the virtual tables 514, depicted as virtual object 514B. In addition, a representation of the first user is depicted as avatar 522.

FIG. 6 depicts an example system set up for presenting components of the multiuser communication session within a usable geometry, according to one or more embodiments. The example system diagram should be understood to be for example purposes and is not intended to be limiting the disclosure.

The view 600 depicts a physical environment of the first user 602, where the first user has moved outside the usable geometry 512. Although physical environment 502 depicts the usable geometry 512 along with virtual components, such as a virtual table 514A and avatar 516, it should be understood that the various components are just intended to be representative of where the various physical and virtual components are located within physical environment 600. As such, physical environment 600 is not intended to depict a realistic view of the environment.

Device 504 depicts the view of the second user after the first user exits the usable geometry 526. Accordingly, the virtual table 514B remains visible, however, the avatar of the first user is no longer visible. In some embodiments, a representation that the user is still active in the session, but is located outside the usable geometry may be provided. Accordingly, visual indication 604 provides an indication that a user is active in the multiuser communication session but is not currently visible. In some embodiments, the visual indication 604 may identify the particular user, such as the first user. Further, in some embodiments, the location of the visual indication may be based on the location of the user outside the usable geometry. For example, as shown in FIG. 6, the intersection between a vector from the local user to the remote user and a boundary of the usable geometry may identify a position at which the visual indication of the remote user may be placed. Accordingly, the visual indication 604 may move along the boundary with the movement of the external user.

In some embodiments, when a user exits a usable geometry in their local physical environment, the local user's view of the multiuser communication session may also change. As shown, device 500 includes a depiction of the physical environment 506 from the new point of view of the first user 602. Accordingly, the display of physical environment 506 may include the desk 520. However, the components of the multiuser communication session within the usable geometry may be obfuscated from the local user. As such, as depicted, the visual indication 606 of the usable geometry may be presented, however, the components of the multiuser communication session within the usable geometry may be obfuscated from the local user. In some embodiments, audio from the multiuser communication session may continue to be presented to the user after the user leaves the usable geometry. Alternatively, the audio from the multiuser communication session may cease to be presented to the user when the user is outside the usable geometry.

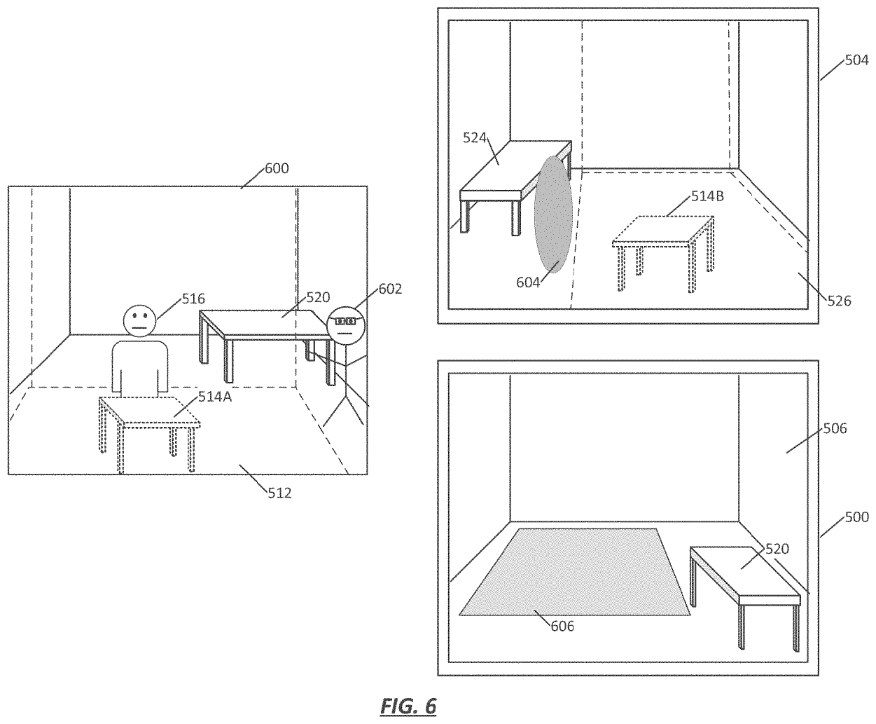

FIG. 7 depicts a flowchart of a technique for presenting an indication of physical objects in the remote environment that affect movements of the remote user, according to one or more embodiments. Specifically, FIG. 7 depicts interactions between a first device 700 and a second device 702. Although the flow diagram shows various procedures performed by particular components in a particular order, it should be understood that according to one or more embodiments, the various processes may be performed by alternative devices or modules. In addition, the various processes may be performed in an alternative order, and various combinations of the processes may be performed simultaneously. Further, according to some embodiments, one or more of the processes may be omitted, or others may be added.

The flowchart begins at block 705, where the first device 700 detects a movement of the local user in a local physical environment. The local movement may be detected based on sensor data, for example from sensors of the first device 700. The flowchart continues to block 710 where a determination is made regarding whether the movement is affected by a physical object in the local environment. According to one or more embodiments, a geometry of the local physical environment may be obtained, for example, by a scan of the physical environment by a local device or device operatively connected to the local device. As another example, the geometry of the environment may be obtained from the geometry data store 160 or the global geometry data store 120. A movement may be affected by a physical object, for example, if a user must maneuver around the physical object. As an example, the physical object may be a furnishing or other item in the physical environment which causes the user to take an indirect route to a destination in the physical environment. A movement may also be affected by a physical object, for example, if a user uses a physical object to interact with a virtual object. As an example, if a user uses a physical surface to place a virtual object.

If a determination is made that the movement is not affected by a physical object, then the flowchart continues to block 720. At block 720, the movement data is transmitted to the remote device 702. The movement data may include data utilized by the remote device to present a representation of the local user moving within the multiuser communication session in a manner representative of the movement detected at 705.

If a determination is made that the movement is affected by a physical object, then the flowchart continues to block 715. At block 715, the local device 700 obtains and transmits physical object characteristics to the remote device 702. In one or more embodiments, the physical object characteristics may be image data of the physical object, geometric information for the physical object, a 3D model of the physical object, and the like. In some embodiments, the physical object may be associated with physical object characteristics of multiple levels of detail. The physical object characteristics transmitted may be of a level of detail based on the type of object, security preferences, characteristics of the remote user, characteristics of the remote device, a relationship between the local user and the remote user, and the like. In addition, the first device 700 transmits movement data to the second device 702.

The flowchart continues at block 725 where the second device 702 receives an indication that the movement is affected by a physical object in the first device's physical environment. For example, the indication that the movement is affected by a physical object may include a representation of the physical object or other data regarding the physical object which affects the movement of the remote user. For example, the indication of the physical object may include a geometry of the physical object, the texture of the vision for the physical object, or the like.

The flowchart continues to block 730 where the second device 702 presents a representation of the physical object based on the physical object characteristics. For example, a virtual object with a similar geometry may be rendered to represent the physical object in the multiuser communication session. The flowchart concludes at block 735, where the second device 702 presents a representation of the first user in the local representation of the multiuser communication session in accordance with the indication. For example, the local device may display the remote representation of the remote user walking around a generated block which may correspond to a coffee table in the remote physical environment. As another example, the movement may include setting a virtual object on top of a physical object in the remote user's physical environment. Accordingly, the virtual object may be placed on a representation of the physical object in the local representation of the multiuser communication session.

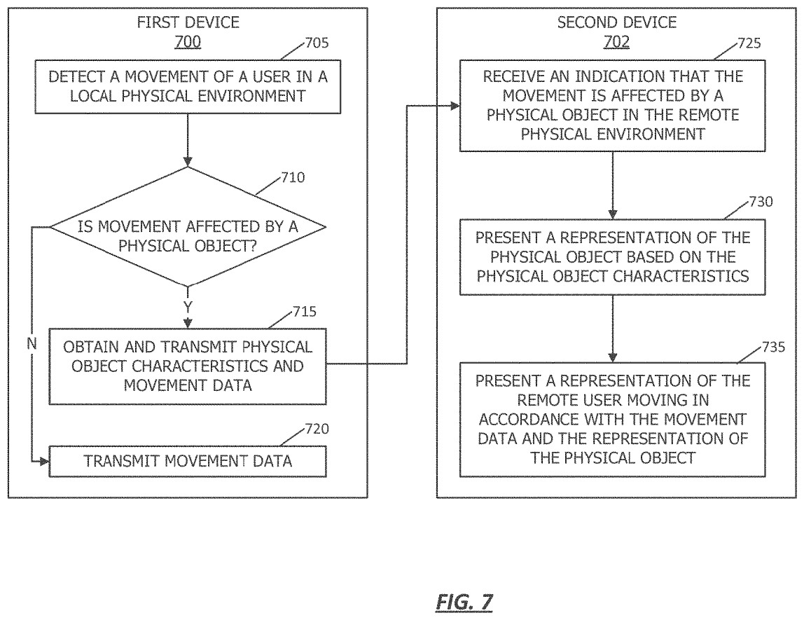

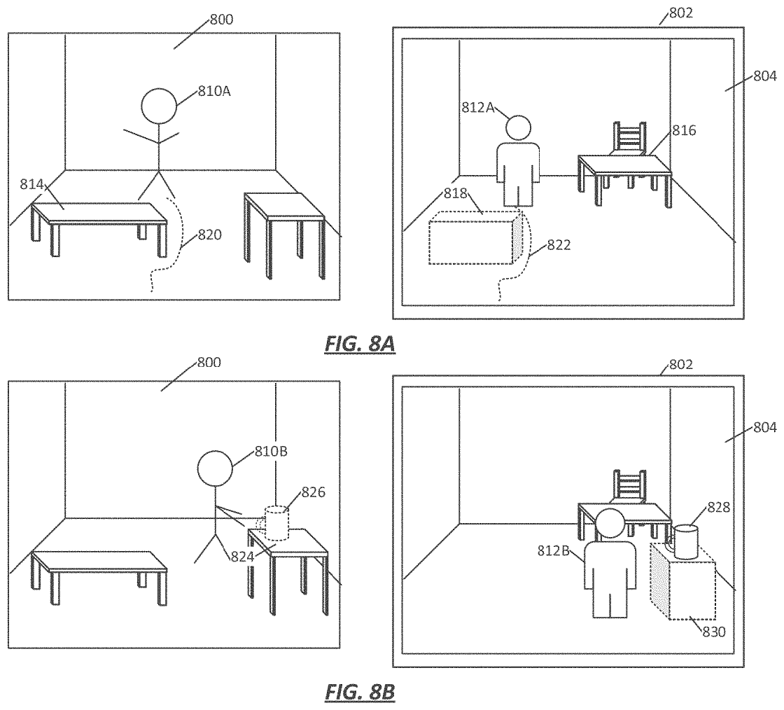

FIGS. 8A-8B show example system diagrams of displays in which a representation of phantom surfaces are presented, according to one or more embodiments.

FIG. 8A depicts a physical environment 800 in which a first user 810 is maneuvering around a physical table 814 along a route 820. In one or more embodiments, the first user 810A may be active in a multiuser communication session with a user of device 802. Meanwhile, device 802 depicts a local presentation of a multiuser communication session 804. The view may include physical objects 816, as well as components of the multiuser communication session, such as avatar 812A, which corresponds to the first user 810A.

In some embodiments, the second device 802 may receive an indication from a device of the first user indicating that the movement of the first user is affected by a physical object in the first user's environment (e.g., table 814). In some embodiments, the second device 802 may receive characteristics of the physical object, such as a geometry of the object. Accordingly, the second device 802 may render a representation of the physical table 818 such that when the avatar 812A walks in an indirect manner toward the second user along path 822, it is clear to the second user that the first user 810A is walking around a physical object in the physical environment of the first user.

FIG. 8B depicts a physical environment 800 in which the first user 810B is placing a virtual object (e.g., virtual mug 826) on a physical table 824. In some embodiments, the second device 802 may receive an indication from a device of the first user indicating that the movement of the first user is affected by a physical object in the first user's environment (e.g., table 824). In some embodiments, the second device 802 may receive characteristics of the physical object, such as a geometry of the object. Accordingly, the second device 802 may render a representation of the physical table 830 such that when the avatar 812B places the virtual mug 826 on the physical table 824, it is clear to the second user that the local representation of the virtual mug 828 is set on a representation of the physical table 830.

In some embodiments, the virtual content may be presented within a shared space container in a physical environment. That is, shared virtual objects, avatars, and the like may be presented within a confined geometric area described herein as a shared space container. In some embodiments, the shared space container may be anchored in a physical environment in a number of ways. For example, the shared space container may be placed in a default position in an environment, such as a central location in the room, along the predefined surface, or the like. In some embodiments, a room may be evaluated for determination of the location of the shared space container. For example, a physical room may be scanned to determine a best location at which the shared space container should be placed.

In some embodiments, the shared space container is placed in accordance with an anchor, where in the anchor may be virtually placed in the physical environment, such as a surface in the physical environment. As such, the shared space container may be presented in accordance with the placement of the anchor. For example, if the anchor is placed on a surface, such as a particular location on the floor of a physical environment, then the associated shared space container may be presented at a location in the physical environment in association with the particular location, such as directly abutting the anchor, floating near the anchor, or the like. In some embodiments, the anchor may be movable by a user. For example, a user may utilize a gesture to select the anchor and place it at a different location in the physical environment. As will be described below, and updated location for the shared space container may not impact a relative presentation of virtual items within the shared space container. In some embodiments, movement of the shared space container in relation to a user moving the shared space container may result in the presentation of a representation of the local user in remote instances of the shared space container corresponding to the updated changed perspective or distance between the user and the shared space container in the user's physical environment.

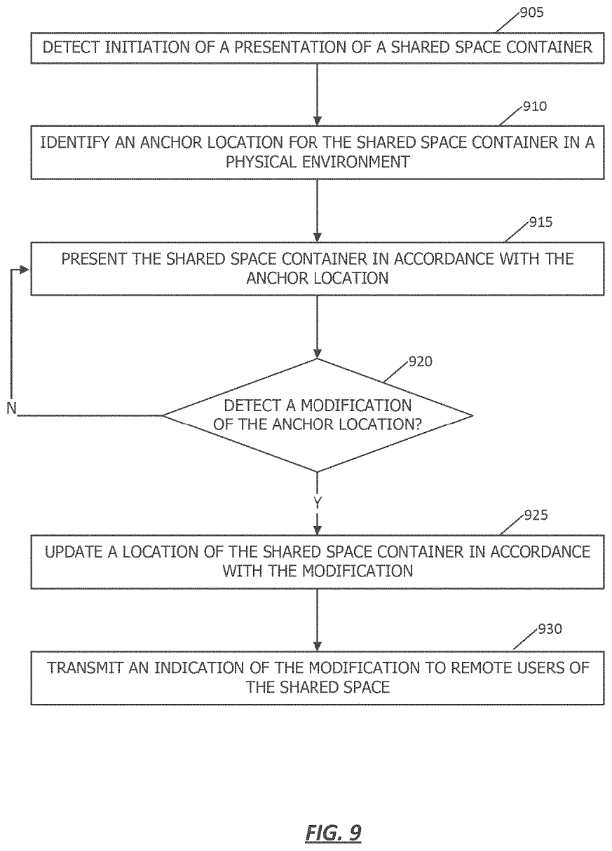

FIG. 9 depicts a flowchart of a technique for updating the location of the shared space container in accordance with a modified anchor location, in accordance with one or more embodiments. For purposes of explanation, the flowchart is described utilizing example components from FIG. 1. Although the flowchart shows various procedures performed by particular components in a particular order, it should be understood that according to one or more embodiments, the various processes may be performed by alternative devices or modules. In addition, the various processes may be performed in an alternative order, and various combinations of the processes may be performed simultaneously. Further, according to some embodiments, one or more of the processes may be omitted, or others may be added.

The flowchart begins at 905 where initiation of the presentation of the shared space container is detected. The initiation of the presentation may be presented, for example, when a user launches an application associated with the shared space container, powers up a device presenting the shared space container, or the like. For example, referring to FIG. 1, a user of electronic device 100 may launch XR module 165.

The flowchart continues at block 910 where an anchor location is identified for the shared space container in the physical environment. In some embodiments, the anchor location may be a default location predefined by a user, or predefined in association with the physical environment. In some embodiments, the anchor location may be identified by user input. For example, a user may be prompted to select an anchor location in the physical environment, such as by selecting a location on the surface such as a floor or wall at which the anchor is to be located. Additionally, or alternatively, electronic device 100 may scan a physical environment, for example by geometry module 170 to identify a suitable anchor location.

The flowchart continues at block 915, where the shared space container is presented in accordance with the anchor location. In some embodiments, the shared space container may encompass a predefined geometry in which virtual items are presented, such as a plane, a cylinder, or other 2D or 3D shape. In some embodiments, the shared space container may be presented adjacent to the anchor location, or some distance from the anchor location. For example, in some embodiments the shared space container may be presented at a predefined distance from the surface at which the anchor location is located.

At block 920, a determination is made as to whether modification of the anchor location is detected. For example, the computer system may monitor for user input requesting movement of the anchor location, or user input to otherwise trigger a change in location of the shared space container. If the anchor location is not moved, or the shared space container is not caused to be displayed in a new location, then the flowchart returns to block 915 and the shared space container continues to be presented in accordance with the anchor location.

Returning to block 920, if a determination is made that the anchor location is modified, then the flowchart continues to block 925. For example, the anchor location may be modified in response to a user utilizing user input to select a new location for the anchor, such as on the surface of the physical environment. In another example, the anchor location may be automatically moved, for example based on characteristics of the physical environment, such as a physical location of the user or other items in the physical environment. In some embodiments, the anchor location may be automatically moved based on contents of the shared space container associated with the anchor location. For example, if an application is loaded that causes virtual objects to be presented that do not fit at the current location of the shared space container, the geometry module 170 may scan the physical environment or detect a new potential location for the anchor. In some embodiments, the user may move the anchor to another location at a same or similar height, or at a different height.

At block 925, the location of the shared space container is updated in accordance with the modification. According to some embodiments, the presentation of the contents of the shared space container may stay consistent even as the location of the shared space container moves within the physical environment. Said another way, in some embodiments, the contents of the shared space container may stay consistent among each other even as the location of the shared space container moves within the physical environment.

As described above, the user may move the anchor to a surface at a same or similar height as the original surface. For example, the system may prompt the user to select an anchor location at a particular location, or on a surface at a same or similar height from a floor surface as the original anchor location. In some embodiments, the location of the shared space container may be modified by determining a spatial difference between the original anchor location and the second anchor location, such as a translation in 3D space, a difference in height from a floor surface, and the like. The system may present the shared space container at a same or similar height as the original anchor location, and/or may extend or reduce a height from the surface at which the shared space container is presented based on the spatial difference.

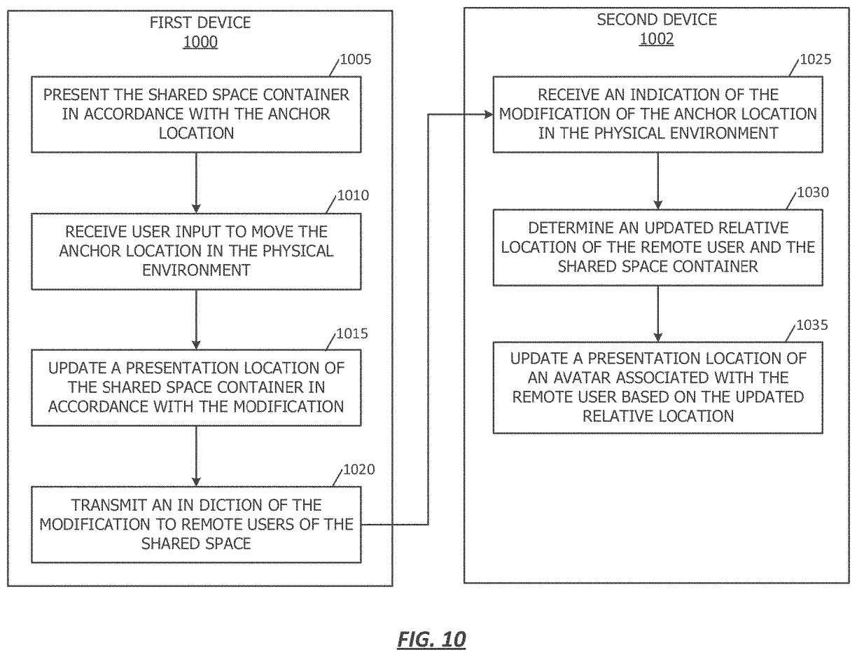

The flowchart concludes at block 930, where an indication of the modification is transmitted to remote users of the shared space. The indication may include, for example, a relative distance and/or direction of the original anchor location to the new anchor location. In some embodiments, the indication may include a relative distance and/or direction of the updated location of the shared space container in relation to the user in the same physical environment as the moved shared space container. As will be described below with respect to FIG. 10, an instance of the shared space container at the remote user's physical environment may be updated in accordance with the indication.

FIG. 10 depicts a flowchart of a technique for updating a presentation of the shared space container at multiple devices in accordance with one or more embodiments. For purposes of explanation, the flowchart is described utilizing example components from FIG. 1. Although the flowchart shows various procedures performed by particular components in a particular order, it should be understood that according to one or more embodiments, the various processes may be performed by alternative devices or modules. In addition, the various processes may be performed in an alternative order, and various combinations of the processes may be performed simultaneously. Further, according to some embodiments, one or more of the processes may be omitted, or others may be added.

The flowchart begins at block 1005, where the shared space container is presented by the first device 1000, in accordance with an anchor location. As described above, the anchor location may be set by a user of the first device 1000, maybe a default location in a physical environment in which first device 1000 is located, or the like. The anchor location may be presented with an indicator at the anchor location, or may not be presented in some embodiments. The flowchart continues at block 1010, where the first device 1000 receives user input to move the anchor location in the physical environment of the first device 1000. In some embodiments, the user input may consist of a user selecting a new location, such as a location on the physical surface within the physical environment, at which the anchor should be located. In some embodiments, the user input may be another type of selection by which a user determines a new location for the anchor. In some embodiments, the user may be prompted to select a new anchor location if the current anchor location is no longer suitable, for example based on the contents of the shared space container. Additionally, or alternatively, the anchor location may be removed automatically, for example based on characteristics of the shared space container and/or the physical environment of the first device 1000.

The flowchart continues at block 1015, where the presentation of the shared space container is updated to be presented in a location in accordance with the modification at block 1010. For example, the shared space container may be presented at or near the updated anchor location. The flowchart continues to block 1020, where an indication of the modification is transmitted to remote users of the shared space. For example, and the indication of the modification may be transmitted to second device 1000.

At block 1025, second device 1002 receives the indication of the modification of the anchor location in the physical environment of first device 1000. The indication of the modification may include, for example, a translation in 2D space across the surface based on the original and updated anchor location, or a translation in 3D space within the environment based on the original and updated anchor location. At block 1030, second device 1002 determines an updated relative location of the remote user and the shared space container in the physical environment of the first device 1000. For example, the indication may include a distance and or direction between the user of the first device 1000 and the presentation of the shared space container. For example, the relative location may be determined based on the anchor location in the physical environment of the first device 1000. As another example, the updated relative location may include some indication of a movement of the shared space container in the physical environment of first device 1000, for example, in a common coordinate system with second device 1002. In some embodiments, the location of the remote user may be tracked separate from the anchor location, and the user's location in the environment may be used to determine the updated relative location.

The flowchart concludes at block 1035, where the presentation of an avatar for a user associated with the first device 1000 is updated for presentation by second device 1002 based on the updated relative location. For example, if the user of first device 1000 moves the anchor location closer toward the first user, then the second device 1002 may present the avatar of the user of first device 1000 as appearing closer to the user of second device 1002 or closer to an anchor location of the shared space container in the physical environment of second device 1002. Alternatively, if the user of first device 1000 moves the anchor location to a location further away from the user, then the updated presentation by the second device 1002 will present the avatar representing the user a first device 1000 as appearing further away from the user of second device 1002 or further away from an anchor location of the shared space container in the physical environment of second device 1002. Moreover, other changes in relative location between the user of the first device 1000 and the location of the shared space container in the physical environment of 1000 will be represented by the updated presentation of the avatar at 1035 by second device 1002, such as a changed perspective and the like. For example, in some embodiments, a change in height from an original anchor location to an updated anchor location may cause a height of the shared space container. Alternatively, in some embodiments, a height of the anchor location may be ignored, and the height of the shared space location may remain constant, for example based on a predetermined height, a height of the user, or the like.

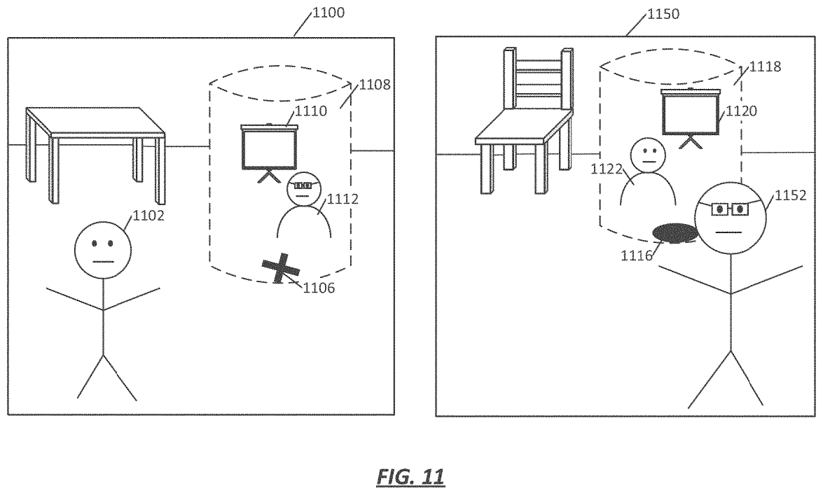

FIG. 11 depicts an example of shared space containers in different physical environments, in accordance with one or more embodiments. Specifically, FIG. 11 depicts users viewing a shared space container in separate physical environments. In particular, FIG. 11 includes a first physical environment 1100 in which a first user 1102 is located, and a second physical environment 1150 in which a second user 1152 is located.

In some embodiments, each user 1102 and 1152 may view a shared space container as it is presented by a corresponding electronic device (not shown). As such, the first physical environment 1100 includes a presentation of a first instance of the shared space container 1108, while the second physical environment 1150 includes a presentation of a second instance of the shared space container 1118. As described above, the shared space container may be a geometry in which virtual objects are presented for a shared session between two users. Each of the two instances of the share space container 1108 and 1118 depict shared virtual objects, such as virtual presentation panel 1110 and 1120. In addition, each instance of the shared space container 1108 and 1118 include a representation of the other users in the shared session. As such, shared space container 1108 includes an avatar 1112 corresponding to user 1152. Similarly, shared space container 1118 includes an avatar 1122 corresponding to user 1102. Accordingly, as user 1102 interacts with the presentation panel 1110, the interaction will be depicted as an interaction between avatar 1122 and presentation panel 1120 in shared space container 1118. Similarly, as user 1152 interacts with the presentation panel 1120, the interaction will be depicted as an interaction between avatar 1112 and presentation panel 1110 in shared space container 1108.

As described above, each instance of the shared space container may be presented in the physical environment in accordance with a corresponding anchor. As such, anchor 1106 in the first physical environment 1100 governs the presentation location of shared space container 1108 in the first physical environment 1100, whereas anchor location 1116 governs the presentation location of the shared space container 1118 in the second physical environment 1150. As will be described below, the anchors 1106 and 1116 may be movable by user interaction, according to one or more embodiments.

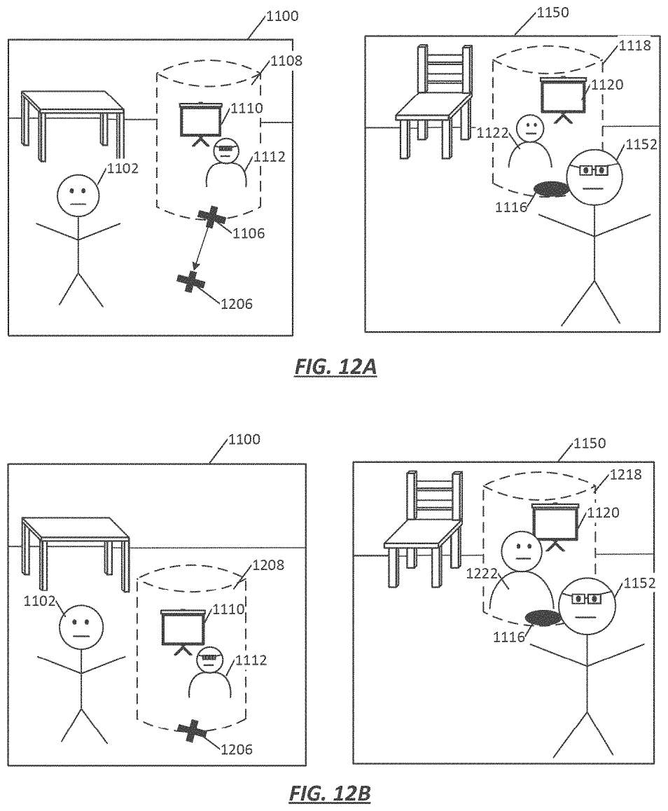

FIGS. 12A-12B depict examples of shared space containers in different environments based on an updated shared space container location, in accordance with one or more embodiments.

In FIG. 12A, physical environments 1100 and 1150 each include an instance of the shared space container 1108 and 1118 as it is viewable by corresponding users 1102 and 1152, for example, through a corresponding electronic device (not shown). Shared space container 1108 is initially located in accordance with anchor location 1106 in physical environment 1100, while share space container 1118 is initially located in accordance with anchor location 1116 in physical environment 1150. As described above, the anchor location may be movable by a user, or a user may otherwise augment the location of the anchor location. As shown, user 1102 in physical environment 1100 may move the anchor location from an original location 1106 to an updated location 1206.

FIG. 12B shows the change in presentation of the shared space containers in accordance with the updated location of the anchor from original anchor location 1106 to 1206. Specifically, the shared space container 1208 is now presented with respect to the updated anchor location 1206. Notably, the contents of the shared space container 1208 appear consistent as in shared space container 1108 prior to the movement to the new location.

Meanwhile, with respect to the second physical environment 1150, the anchor location 1116 remains the same as in FIG. 12A. As such, the location of share space container 1218 remains consistent with 1118 from FIG. 12A. In addition, the contents of some of the virtual objects remain the same. Accordingly, as shown, the presentation of the virtual presentation panel 1120 remains consistent as it was presented in FIG. 12A. However, as described above, the device of user 1152 will receive an indication of the change in location of the shared space container 1208 resulting from user 1102 moving the anchor from the original anchor location 1106 to the updated anchor location 1206. Accordingly, the presentation of avatar 1222 corresponding to user 1102 will be modified to represent the updated spatial relationship between user 1102 and shared space container 1208. Because user 1102 moved the shared space container 1208 (including shared virtual objects 1110 and 1112) closer to the user than at the prior location of shared space container 1108, avatar 1208 is presented in shared space container 1218 as being closer to user 1152 and virtual presentation panel 1120 than in shared space container 1118 to indicate the change in perspective since they are the physical and virtual counterparts to virtual presentation panel 1110 and avatar 1112. In some embodiments, the placement of the avatar in shared space container 1218 may also be updated to represent a change perspective between the user 1102 and the shared space container 1208 in the first physical environment 1100.

In some embodiments, presentation of objects within the multiuser communication session may change based on a shared or unshared status, or whether a user is interacting with the object. For example, a particular user in a particular physical environment may have multiple virtual objects, such as application instances, open and active in a session. In order to refine presentation for other users in the multiuser communication session, the presentation of virtual objects may be reduced, for example, based on representations of objects that are shared, or objects that a user is interacting with.

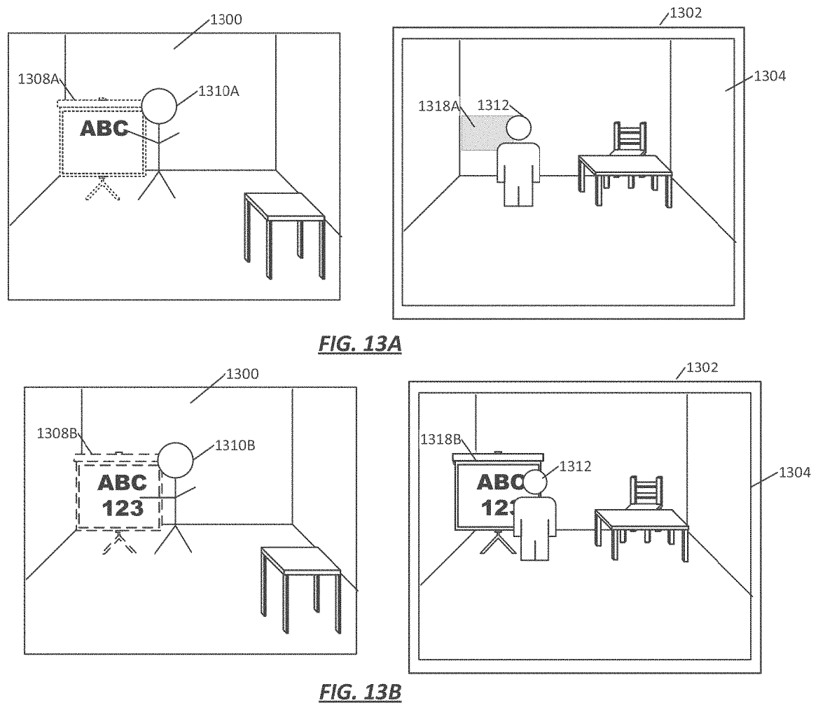

FIG. 13A and FIG. 13B depict example views of a physical environment in which a multiuser communication session is active. In particular, FIG. 13A and FIG. 13B depict an example of a presentation of an unshared object in a multiuser communication session.

FIG. 13A shows a physical environment 1300 in which a first user 1310 is interacting with a virtual application shown in the form of presentation panel 1308A. For purposes of this example, presentation panel 1308A is an unshared virtual object. That is, presentation panel 1308A is usable by user 1310A but not other users in the multiuser communication session. While presentation panel 1308A is shown within physical environment 1300, it should be understood that presentation panel 1308A is visible through an electronic device utilized by user 1311A and is not actually present in the physical environment 1300.

In one or more embodiments, the first user 1310A may be active in a multiuser communication session with a user of device 1302. Meanwhile, device 1302 depicts a local presentation of the multiuser communication session 1304. The view may include a representation of user 1310A as avatar 1312A. In one or more embodiments, the second device 1302 may receive an indication from a device of the first user indicating that the user 1310A is interacting with a virtual object 1308A that is not shared with the user of device 1302. In some embodiments, the second device 1302 may receive a representation of the unshared object, such as a geometry of the virtual object 1308A, a location of the virtual object 1308A, and the like. In some embodiments, the representation may be an obfuscated version of the unshared virtual object 1308A. Accordingly, the second device 1302 may render a representation 1318A of the unshared virtual object 1308A as representation 1318A, such that when the user 1310A interacts with the unshared virtual object 1308A, it is clear to the user of device 1302 that the user 1310A is interacting with the unshared virtual object 1318A.

FIG. 13B depicts the physical environment 1300 in which the first user 1310B has shared the virtual object 1308B. In some embodiments, the second device 1302 may receive an indication from a device of the first user indicating that the virtual object 1318 is now a shared virtual object. In some embodiments, the second device 1302 may receive an updated representation of the virtual object when it becomes a shared object, such that the user of device 1302 views a consistent version of the virtual object 1308B as representation 1318B within the display 1304. Accordingly, the second device 1302 may render a representation of the virtual object 1318B such that when user 1310B modifies the virtual object 1308B, the avatar 1312 modifies the representation of the virtual object 1318B presented within display 1304.

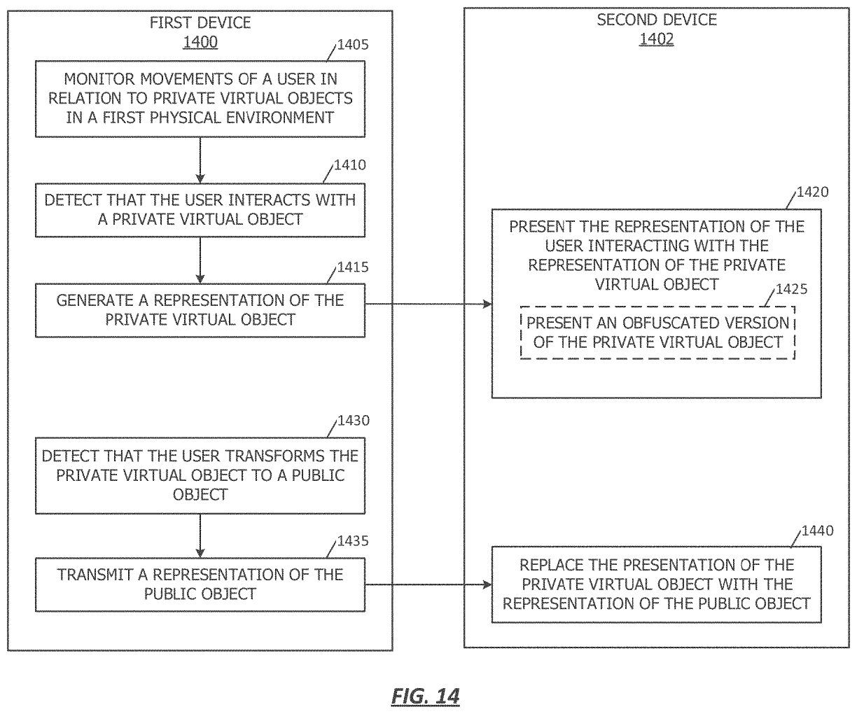

FIG. 14 illustrates a flowchart of a technique for presenting shared and unshared virtual objects within a multiuser communication session. More specifically, FIG. 14 illustrates a technique for modifying presentation of virtual objects among a first device 1400 and a second device 1402 based on user interaction. For purposes of explanation, the flowchart is described utilizing example components from FIG. 1. Although the flowchart shows various procedures performed by particular components in a particular order, it should be understood that according to one or more embodiments, the various processes may be performed by alternative devices or modules. In addition, the various processes may be performed in an alternative order, and various combinations of the processes may be performed simultaneously. Further, according to some embodiments, one or more of the processes may be omitted, or others may be added.

The flowchart begins at block 1405 where the first device 1400 monitors movements of a user in relation to private (or unshared) virtual objects in a first physical environment. The local movement may be detected based on sensor data, for example from sensors of the first device 1200. In one or more embodiments, the first device 1400 may also track the location of the virtual objects within the physical environment in order to track a user's movement in relation to the virtual objects. The flowchart continues to block 1410 where the first device 1400 detects that the user of the first device 1400 interacts with a private virtual object. The private virtual object may be a virtual object that is considered private if it is note shared with second device 1402. The interactions of the user with the private virtual object may be determined, for example, based on whether the user of first device 1400 is actively engaged with the private virtual object. Further, in some embodiments, the user may be considered to be interacting with the private virtual object based on a gaze direction of the user, such as if the user is viewing the private virtual object. As another example, a distance threshold may be utilized. That is, if a user is within a predetermined, for example based on hand tracking or head tracking techniques, then a determination may be made that the user is interact with the unshared or private virtual object.

The flowchart continues at block 1415 where a representation of the private virtual object is generated. The representation may be a representation of the private virtual object in less detail than that presented by first device 1400. For example, the representation of the private virtual object may be represented as a geometry of the virtual object with a texture or content obfuscated. As another example, a plane may be provided which is associated with the location of the private virtual object as it is presented by first device 1400. In some embodiments, the representation may be a portion of the geometry, or a plane representing a portion of the geometry which is presented at or near where the user is interacting with the private virtual object, such as a portion of the private virtual object where the user is looking or otherwise interacting. The representation is then transmitted to second device 1402 and, at block 1420, the second device 1402 presents the representation of the user interacting with the representation of the private virtual object. For example, an avatar of the user of first device 1400 may be presented interacting with the representation of the private virtual object generated at block 1415. As shown at block 1425, in some embodiments, an obfuscated version f the private virtual object may be presented. For example, the texture or the content of the private virtual object may not be visible when the representation of the private virtual object is presented by second device 1402.

The flowchart continues at block 1430. At block 1430, the first device 1400 detects that the user transforms the private virtual object to a public object. For example, first device 1400 may allow a user to toggle between privacy settings for virtual objects such that the private virtual object may be shared with other devices and, thus, become public virtual objects. The flowchart continues at block 1435 where the first device 1400 transmits a representation of the public object to the second device 1402. The representation of the public object may be a representation of the public virtual object that is consistent in presentation to that presented y first device 1400. The flowchart concludes at block 1440 where the second device 1402 replaces the presentation of the private virtual object with the representation of the public object. Specifically, because the private virtual object is transformed to a public virtual object, for example if the user of first device 1400 makes the private virtual object accessible to a user of second device 1402, then the initial representation presented at block 1420 will be replaced by a representation that is visually consistent with the version of the virtual object presented by first device 1400.

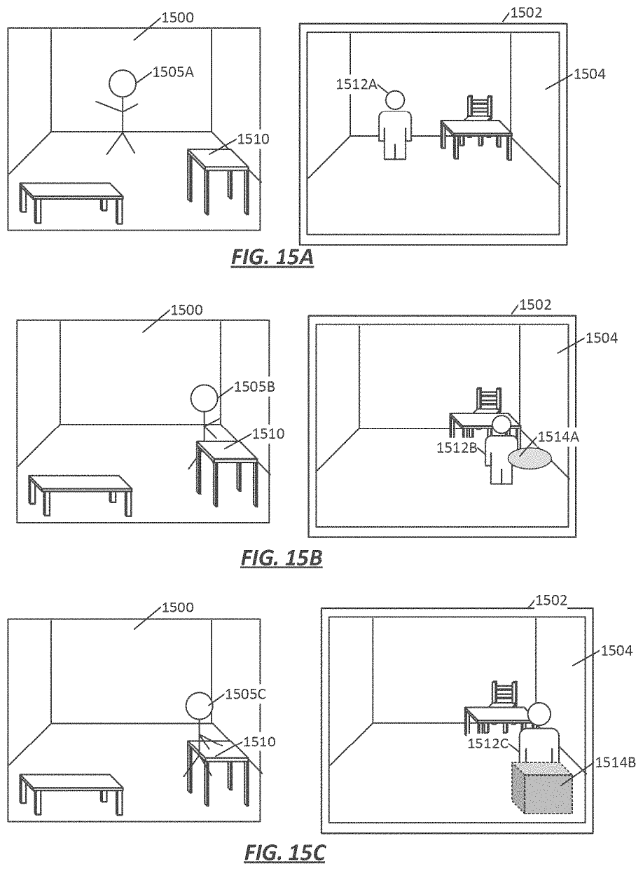

FIGS. 15A-C depict example views of physical environments in which a multiuser communication session is active. In particular, FIGS. 15A-C depict an example of a presentation in a first physical environment of a representation of a physical object in a second physical environment. According to some embodiments, as a user approaches a physical object in a physical environment, an indication of the physical objects may be presented to other users in the multiuser communication session to provide context around the user's movements. In some embodiments, the representation of the physical objects may be presented in various levels of detail, depending upon, for example, a proximity of the user to the physical object.

FIG. 15A depicts a physical environment 1500 in which a first user 1505A is standing in the middle of the room, and is not near any physical surfaces. Accordingly, a user of device 1502 may see a display 1504 of the multiuser communication session in which avatar 1512A represents user 1505A. While user 1505A is in a physical environment 1500 include a physical table 1510, the representation of the physical table is not presented by device 1502 because the user 1505A is no near the table 1510.

FIG. 15B depicts the physical environment 1500 in which user 1505B approaches a physical table 1510. Meanwhile, device 1502 depicts a local presentation of the multiuser communication session 1504. The view may include a representation of the physical table 1510 as representation 1514A, as well as components of the multiuser communication session, such as avatar 1512B, which corresponds to the first user 1505B. According to one or more embodiments, because the user 1505B is merely approaching the physical table 1510 and is not interacting or touching the physical table 1510, a first representation of the physical table 1514A is presented by device 1502. The first level of detail may be, for example, a small plane or geometry “spotlight” of the physical table 1510 may be presented.

FIG. 15C depicts the physical environment 1500 in which user 1505C interacts with the physical table 1510. For example, the user 1505C may make physical contact with the physical table 1510. Meanwhile, device 1502 depicts a local presentation of the multiuser communication session 1504. The view may include a representation of the physical table 1510 as representation 1514B, as well as components of the multiuser communication session, such as avatar 1512C, which corresponds to the first user 1505C. According to one or more embodiments, because the user 1505C is physically interacting with physical table 1510, a second representation of the physical table 1514B is presented by device 1502. The second level of detail may include a greater level of detail than the first level of detail. For example, a 3D geometry or volume of the physical table 1510 may be presented, as shown at 1514B. In some embodiments, a virtual version of the physical object may be presented. In addition, the avatar 1512C may be presented as interacting with the representation 1514C to give context to the actions of user 1505C within physical environment 1500.

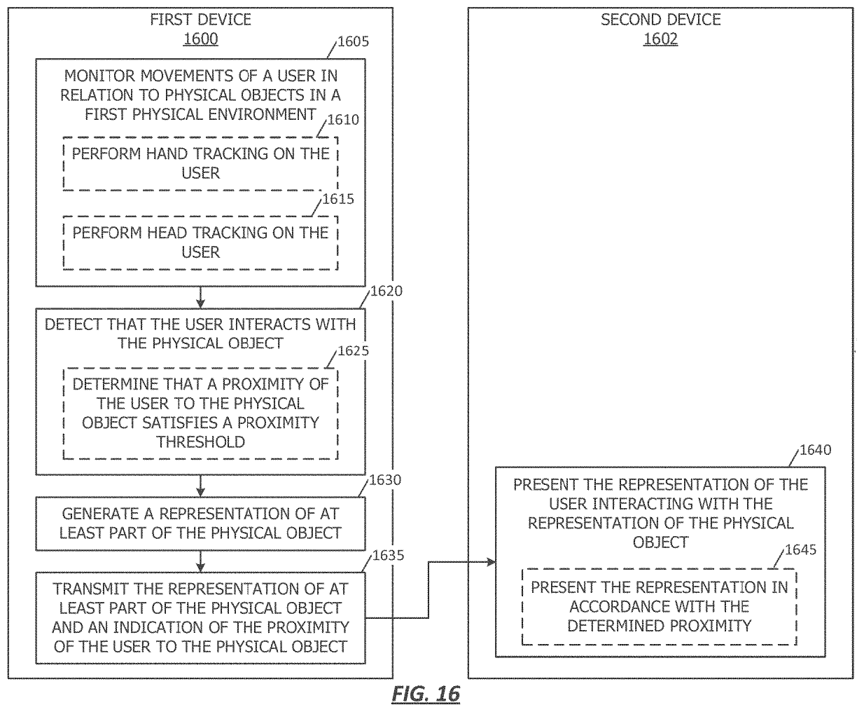

FIG. 16 depicts a flowchart of a technique for generating a representation of a physical object in a multiuser communication session, in accordance with one or more embodiments. Specifically, FIG. 16 depicts a technique for presenting a representation of a physical object in a multiuser communication session in which first device 1600 and second device 1602 are active, based on a proximity of a user to the physical object. For purposes of explanation, the flowchart is described utilizing example components from FIG. 1. Although the flowchart shows various procedures performed by particular components in a particular order, it should be understood that according to one or more embodiments, the various processes may be performed by alternative devices or modules. In addition, the various processes may be performed in an alternative order, and various combinations of the processes may be performed simultaneously. Further, according to some embodiments, one or more of the processes may be omitted, or others may be added.

The flowchart begins at block 1605, where the first device 1600 monitors movements of a user in relation to one or more physical objects in a first physical environment. For example, in some embodiments, a geometry of the local physical environment may be obtained, for example, by a scan of the physical environment by a local device or device operatively connected to the local device. As another example, the geometry of the environment may be obtained from the geometry data store 160 or the global geometry data store 120. The physical objects may include, for example, real world objects within a room such as furniture and decor, as well as planes such as walls, floors, ceilings, surfaces, and the like within the environment. The user's movement may be tracked in a number of ways. For example, as shown at block 1610, hand tracking techniques may be used to detect whether a user is approaching, touching, or otherwise interacting with a physical object with the user's hands. As another example, as shown at block 1615, head tracking may be performed on the user. For example, the user may be wearing a head mounted device which contains sensors used to track the device within the physical environment. By comparing the location of the user with the location of the physical objects in the environment, the movements of the user may be monitored with respect to the physical environment.

The flowchart continues at block 1620 where the first device 1600 detects that the user of first device 1600 interacts a physical object. The interaction may be defined based on a user touching or grasping an object, a user viewing an object, a user manipulating an object, and the like. As shown at block 1625, optionally, the user interaction may be detected when first device 1600 determines that a proximity of the user (e.g., the user's head or hand) to the physical object satisfies a proximity threshold. For example, when part of the user is within a threshold distance of a physical object, interaction may be inferred. In some embodiments, multiple proximity thresholds may be used, as described above with respect to FIG. 15. For example, a first proximity threshold may be used to determine that a user is approaching the physical object, and a second proximity threshold may be used to determine that the user is making contact with the physical object. Similarly, any number of proximity thresholds may be utilized to determine various levels of user interaction, according to some embodiments.

The flowchart continues at block 1630 where a representation of at least part of the physical object is generated. In some embodiments, the amount or level of detail included in the representation of the at least part of the physical object may be based on the level of proximity determined above with respect to block 1625. For example, a 2D or 3D geometry, such as a volume of an object, may be used. In some embodiments, other visual characteristics of the representation may vary based on the proximity. For example, in some embodiments, as a user approaches a physical object, and as the proximity is reduced, a level of opaqueness of the representation may increase. At block 1635, the representation of the at least part of the physical object is transmitted to the second device 1602, and in some embodiments an indication of the proximity of the user to the physical object may also be transmitted. For example, the level of opaqueness or other visual variation may not be “built in” to the representation generated at block 1630, but may be modified by second device 1602 at presentation time.

The flowchart concludes at block 1640, where the second device 1602 presents the representation of the user interacting with the representation of the physical object. For example, an avatar representing the user of first device 1600 may be presented interacting with the representation of the physical object to provide context to the user's real-world movements within the physical environment in which the user is participating in the multiuser communication session. Optionally, as shown at 1645, the representation may be presented in accordance with the determined proximity. As described above, one or more visual characteristics of the representation may be presented in a manner that is based on a particular proximity. For example, as described above, in some embodiments, the opacity of the representation may be dynamically modified based on the proximity of the user to the physical object represented by the representation. As another example, a level of detail may vary based on the proximity of the user to the physical object.

In some embodiments, a user may manipulate a virtual object to move presentation of the virtual object to a new location within a physical environment. However, in some embodiments, it is preferable to place the virtual object in a location that allows for spatial consistency among users of the multiuser communication session. As such, in some embodiments, techniques allow a user to view a representation of physical objects in remote environments of other users participating in the multiuser communication session in order to improve the ability to select an updated location for the virtual object.

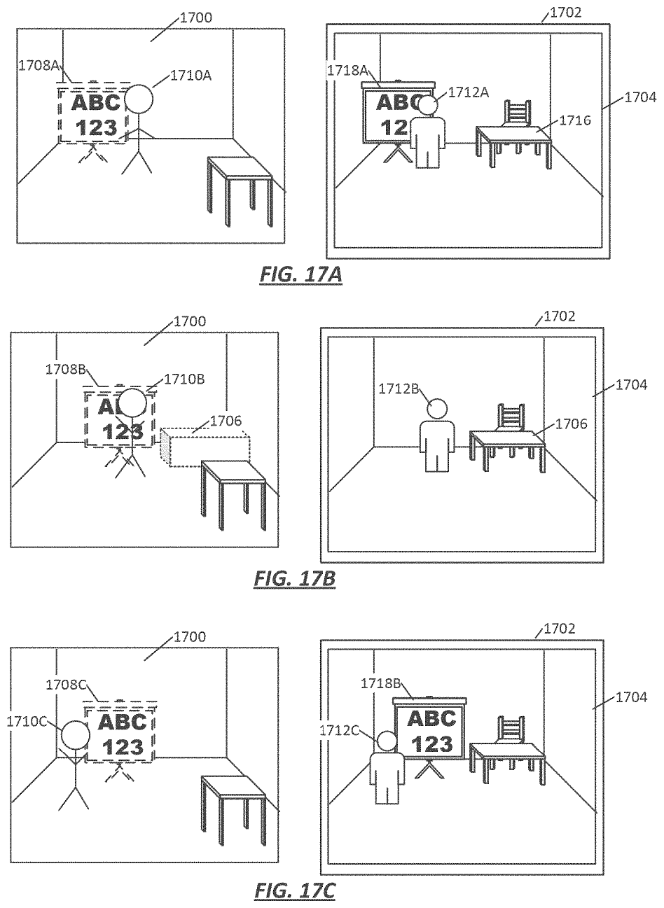

FIGS. 17A-C depict example views of physical environments in which a multiuser communication session is active. In particular, FIGS. 17A-C depict an example of a movement of a shared virtual object by one user in a multiuser communication session.

FIG. 17A shows a physical environment 1700 in which a first user 1710A is interacting with a virtual application shown in the form of virtual presentation panel 1708A. For purposes of this example, virtual presentation panel 1708A is a shared virtual object. That is, presentation panel 1308A is usable by user 1310A and by other users in the multiuser communication session, such as a user of device 1702. While presentation panel 1708A is shown within physical environment 1700, it should be understood that presentation panel 1708A is visible through al electronic device utilized by user 1701A and is not actually present in the physical environment 1700.

In one or more embodiments, the first user 1710A may be active in a multiuser communication session with a user of device 1702. Meanwhile, device 1702 depicts a local presentation of the multiuser communication session 1704. The view may include a representation of user 1710A as avatar 1712A. In one or more embodiments, the second device 1702 may provide a representation of the user 1710A interacting with virtual object 1708A, as shown as avatar 1712A interacting with virtual object 1718A. As is visible in display 1704, the second physical environment (e.g., the physical environment in which device 1702 is participating) includes a physical desk 1716. The physical desk 1716 may be visible to the user of device 1702, for example when using a pass through display. By contrast, the physical desk 1716 is not visible within the first physical environment 1700.

FIG. 17B depicts the physical environment 1700 in which the first user 1710B has initiated movement of the virtual object 1708B within the physical environment 1700. According to some embodiments, a user may initiate the movement process by user input, such as a predetermined gesture, audio prompt, or the like. In one or more embodiments, in response to detecting that the user 1710B is initiating movement of the virtual object 1708B, a device used by user 1710B may present an indication of physical objects in remote environments in which other uses are participating in the multiuser communication session. Accordingly, representation 1706 represents physical desk 1706 of the second physical environment. By doing so, a user's experience is enhanced being able to select an optimal location for the virtual object 1708B for both the local user and the remote user of device 1702. Further, in some embodiments, as the user 1710B is moving the virtual object 1708B, the presentation of the virtual object may change in the view 1704 presented by device 1702. As such, device 1702 depicts avatar 1712B representing user 1710B, but does not present a representation of the virtual object 1708B as it is being moved.

At FIG. 17C, physical environment 1700 is shown with virtual object 1708C moved to an updated location. In addition, user 1710C is also shown in an updated location. The new locations are transmitted to device 1702 such that presentation 1704 depicts the representation of the virtual object 1718B in the updated location consistent with the movement as performed by user 1710. In some embodiments, completion of the movement may trigger the virtual object 1718B to be presented. Similarly, avatar 1712C is presented at an updated location, such that spatial consistency remains between the user 1710C and the virtual object 1708C as compared to the avatar 1712C and the virtual object 1718B.

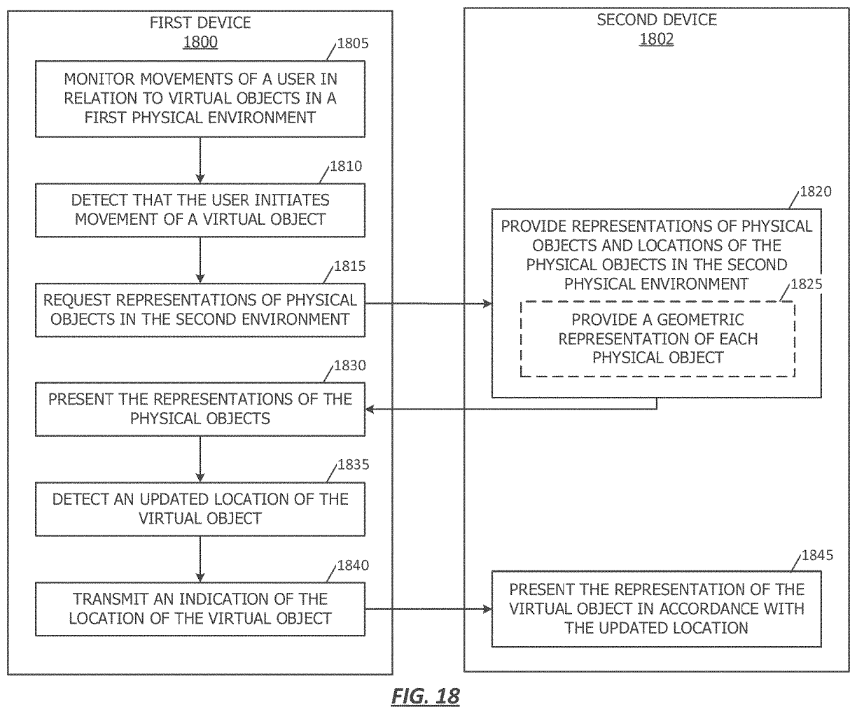

FIG. 18 depicts a flowchart of a technique for movement of a shared virtual object in a multiuser communication session, in accordance with one or more embodiments. In particular, FIG. 18 depicts a flowchart of a technique for presenting, by a first device 1800, representations of physical objects in a remote environment in which second device 1802 is active. For purposes of explanation, the flowchart is described utilizing example components from FIG. 1. Although the flowchart shows various procedures performed by particular components in a particular order, it should be understood that according to one or more embodiments, the various processes may be performed by alternative devices or modules. In addition, the various processes may be performed in an alternative order, and various combinations of the processes may be performed simultaneously. Further, according to some embodiments, one or more of the processes may be omitted, or others may be added.

The flowchart begins at block 1805 where the first device monitors movements of user in relation to virtual objects in a first physical environment. For example, in some embodiments, the device may utilize hand tracking techniques to detect whether a user performs a gesture to initiate movement of a virtual object. At block 1810, the first device 1800 detects that the user initiates movement of a virtual object.

The flowchart continues at block 1815 where, in response to detecting that the user of first device 1800 initiates movement of the virtual object, the first device 1800 obtains (e.g., requests) representations of physical objects in the second environment. That is, the first device 1800 transmits a request 1802 for representations of physical objects located in the physical environment in which second device 1802 is active. In one or more embodiments, location information may also be request for the corresponding physical objects. A block 1820, the second device 1802 provides representations of physical objects and locations of the physical objects in the second physical environment. For example, in some embodiments, a geometry of the physical environment may be obtained by a scan of the physical environment by second device 1802. As another example, the geometry of the environment may be obtained from the geometry data store 160 or the global geometry data store 120. The physical objects may include, for example, real world objects within a room such as furniture and decor, as well as planes such as walls, floors, ceilings, surfaces, and the like within the environment. Optionally, at block 1825, the second device 1802 provides geometric representation of each physical object. For example, in some embodiments, a generic shape may be used to represent a physical object, such as a box or a cylinder. Alternatively, a more detailed geometric representation for the various objects may be provided, such as a volume or a 3D geometry of the object.

At block 1830, the first device 1800 presents the representations of the physical objects in a manner which maintains spatial consistency between the virtual objects and the physical objects as presented by second device 1802. As such, a user may manipulate the virtual object within a view of the local physical environment in which representations of physical objects from the remote physical devices are also visible. The flowchart continues at block 1835, where the first device 1800 detects an updated location of the virtual object.

The flowchart continues at block 1835, where an updated location of the virtual object is detected. In some embodiments, the updated location may be determined when the first device 1800 detects that a user has finalized the movement of the virtual object. The updated location may be determined, for example, in relation to a reference coordinate system, in relation to an original location of the virtual object, or the like. At block 1840, the indication of the updated location of the virtual object is transmitted to the second device. The flowchart concludes at block 1845 where the second device 1802 presents the representation of the virtual object in accordance with the updated location. For example, the representation of the virtual object may be moved from an original location to the updated location as presented by second device 1802.

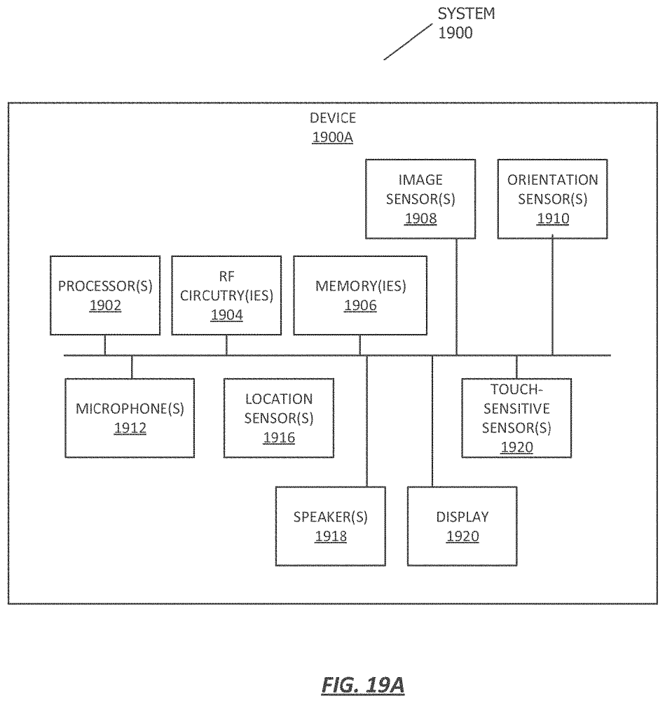

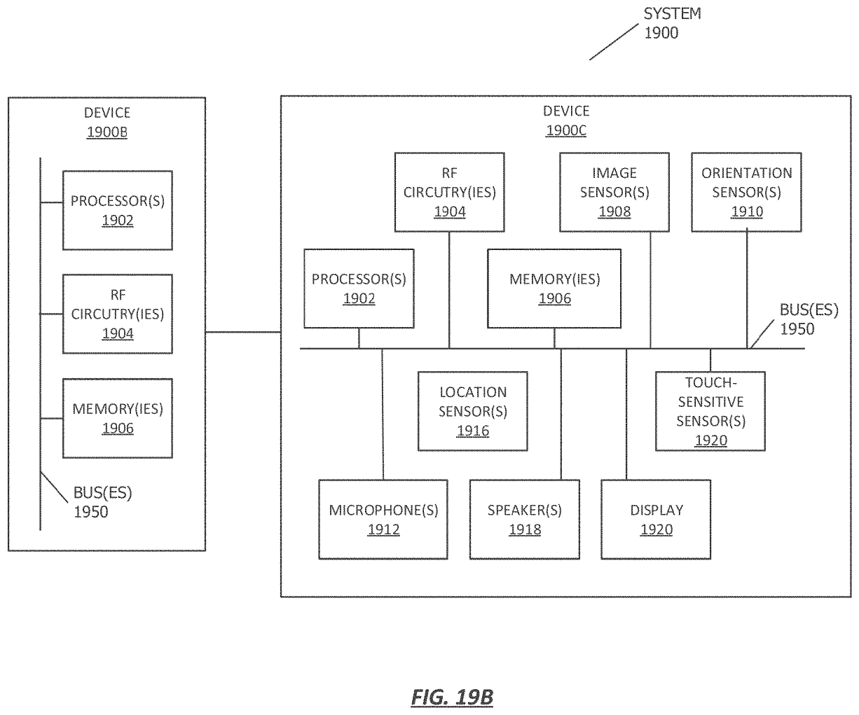

FIG. 19A and FIG. 19B depict exemplary system 1900 for use in various extended reality technologies.

In some examples, as illustrated in FIG. 19A, system 1900 includes device 1900a. Device 1900a includes various components, such as processor(s) 1902, RF circuitry(ies) 1904, memory(ies) 1906, image sensor(s) 1908, orientation sensor(s) 1910, microphone(s) 1912, location sensor(s) 1916, speaker(s) 1918, display(s) 1920, and touch-sensitive sensor(s) 1922. These components optionally communicate over communication bus(es) 1950 of device 1900a.

In some examples, elements of system 1900 are implemented in a base station device (e.g., a computing device, such as a remote server, mobile device, or laptop) and other elements of system 1900 are implemented in a second device (e.g., a head-mounted device). In some examples, device 1900a is implemented in a base station device or a second device.

As illustrated in FIG. 19B, in some examples, system 1900 includes two (or more) devices in communication, such as through a wired connection or a wireless connection. First device 1900b (e.g., a base station device) includes processor(s) 1902, RF circuitry(ies) 1904, and memory(ies) 1906. These components optionally communicate over communication bus(es) 1950 of device 1900b. Second device 1900c (e.g., a head-mounted device) includes various components, such as processor(s) 1902, RF circuitry(ies) 1904, memory(ies) 1906, image sensor(s) 1908, orientation sensor(s) 1910, microphone(s) 1912, location sensor(s) 1916, speaker(s) 1918, display(s) 1920, and touch-sensitive sensor(s) 1922. These components optionally communicate over communication bus(es) 1950 of device 1900c.

System 1900 includes processor(s) 1902 and memory(ies) 1906. Processor(s) 1902 include one or more general processors, one or more graphics processors, and/or one or more digital signal processors. In some examples, memory(ies) 1906 are one or more non-transitory computer-readable storage mediums (e.g., flash memory, random access memory) that store computer-readable instructions configured to be executed by processor(s) 1902 to perform the techniques described below.

System 1900 includes RF circuitry(ies) 1904. RF circuitry(ies) 1904 optionally include circuitry for communicating with electronic devices, networks, such as the Internet, intranets, and/or a wireless network, such as cellular networks and wireless local area networks (LANs). RF circuitry(ies) 1904 optionally includes circuitry for communicating using near-field communication and/or short-range communication, such as Bluetooth®.

System 1900 includes display(s) 1920. Display(s) 1920 may have an opaque display. Display(s) 1920 may have a transparent or semi-transparent display that may incorporate a substrate through which light representative of images is directed to an individual's eyes. Display(s) 1920 may incorporate LEDs, OLEDs, a digital light projector, a laser scanning light source, liquid crystal on silicon, or any combination of these technologies. The substrate through which the light is transmitted may be a light waveguide, optical combiner, optical reflector, holographic substrate, or any combination of these substrates. In one example, the transparent or semi-transparent display may transition selectively between an opaque state and a transparent or semi-transparent state. Other examples of display(s) 1920 include heads up displays, automotive windshields with the ability to display graphics, windows with the ability to display graphics, lenses with the ability to display graphics, tablets, smartphones, and desktop or laptop computers. Alternatively, system 1900 may be designed to receive an external display (e.g., a smartphone). In some examples, system 1900 is a projection-based system that uses retinal projection to project images onto an individual's retina or projects virtual objects into a physical setting (e.g., onto a physical surface or as a holograph).

In some examples, system 1900 includes touch-sensitive sensor(s) 1922 for receiving user inputs, such as tap inputs and swipe inputs. In some examples, display(s) 1920 and touch-sensitive sensor(s) 1922 form touch-sensitive display(s).

System 1900 includes image sensor(s) 1908. Image sensors(s) 1908 optionally include one or more visible light image sensor, such as charged coupled device (CCD) sensors, and/or complementary metal-oxide-semiconductor (CMOS) sensors operable to obtain images of physical elements from the physical setting. Image sensor(s) also optionally include one or more infrared (IR) sensor(s), such as a passive IR sensor or an active IR sensor, for detecting infrared light from the physical setting. For example, an active IR sensor includes an IR emitter, such as an IR dot emitter, for emitting infrared light into the physical setting. Image sensor(s) 1908 also optionally include one or more event camera(s) configured to capture movement of physical elements in the physical setting. Image sensor(s) 1908 also optionally include one or more depth sensor(s) configured to detect the distance of physical elements from system 1900. In some examples, system 1900 uses CCD sensors, event cameras, and depth sensors in combination to detect the physical setting around system 1900. In some examples, image sensor(s) 1908 include a first image sensor and a second image sensor. The first image sensor and the second image sensor are optionally configured to capture images of physical elements in the physical setting from two distinct perspectives. In some examples, system 1900 uses image sensor(s) 1908 to receive user inputs, such as hand gestures. In some examples, system 1900 uses image sensor(s) 1908 to detect the position and orientation of system 1900 and/or display(s) 1920 in the physical setting. For example, system 1900 uses image sensor(s) 1908 to track the position and orientation of display(s) 1920 relative to one or more fixed elements in the physical setting.

In some examples, system 1900 includes microphones(s) 1912. System 1900 uses microphone(s) 1912 to detect sound from the user and/or the physical setting of the user. In some examples, microphone(s) 1912 includes an array of microphones (including a plurality of microphones) that optionally operate in tandem, such as to identify ambient noise or to locate the source of sound in space of the physical setting.

System 1900 includes orientation sensor(s) 1910 for detecting orientation and/or movement of system 1900 and/or display(s) 1920. For example, system 1900 uses orientation sensor(s) 1910 to track changes in the position and/or orientation of system 1900 and/or display(s) 1920, such as with respect to physical elements in the physical setting. Orientation sensor(s) 1910 optionally include one or more gyroscopes and/or one or more accelerometers.

The techniques defined herein consider the option of obtaining and utilizing a user's personal information. For example, such personal information may be utilized in order to provide a multi-user communication session on an electronic device. However, to the extent such personal information is collected, such information should be obtained with the user's informed consent, such that the user has knowledge of and control over the use of their personal information.

Parties having access to personal information will utilize the information only for legitimate and reasonable purposes, and will adhere to privacy policies and practices that are at least in accordance with appropriate laws and regulations. In addition, such policies are to be well-established, user-accessible, and recognized as meeting or exceeding governmental/industry standards. Moreover, the personal information will not be distributed, sold, or otherwise shared outside of any reasonable and legitimate purposes.

Users may, however, limit the degree to which such parties may obtain personal information. The processes and devices described herein may allow settings or other preferences to be altered such that users control access of their personal information. Furthermore, while some features defined herein are described in the context of using personal information, various aspects of these features can be implemented without the need to use such information. As an example, a user's personal information may be obscured or otherwise generalized such that the information does not identify the specific user from which the information was obtained. It is to be understood that the above description is intended to be illustrative, and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 3-4, 7, 9-10, 14, 16, and 18 or the arrangement of elements shown in FIGS. 1, 2, 5, 6, 8, 11-13, 15, 17, and 19 should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
obtaining, at a first device, local size constraint data associated with a local environment in which the first device is located;
obtaining, at the first device, remote size constraint data associated with a remote environment in which a second device is located, wherein the first device and the second device are active in a multi-user communication session;
determining a geometry based on the local size constraint data and the remote size constraint data; and
presenting a representation of the multi-user communication session within the geometry.

2. The method of claim 1, wherein components of the multi-user communication session are presented within the geometry.

3. The method of claim 1, further comprising:
receiving, at the first device, a position of a remote user of the second device relative to a reference point within the geometry; and
presenting, at the first device, a representation of the remote user based on the position of the remote user relative to the reference point.

4. The method of claim 3, further comprising:
determining, at the first device, an updated location within the local environment such that the reference point is located at a new point within the local environment; and
presenting, at the first device, the representation of the remote user based on the position of the remote user relative to the reference point located at the new point within the local environment.

5. The method of claim 1, further comprising generating the local size constraint data based on one or more images of the local environment.

6. The method of claim 1, further comprising generating the local size constraint data based on user input.

7. The method of claim 1, further comprising:
receiving an indication that the remote user has moved to a location outside of the geometry; and
presenting an indication on a boundary of the geometry indicating the remote user moved to the location outside of the geometry.

8. The method of claim 7, further comprising ceasing display of the representation of the remote user in accordance with the indication that the remote user has moved to a location outside the geometry.

9. The method of claim 8, further comprising continuing to play spatial audio associated with the remote user from the location outside of the geometry.

10. The method of claim 1, further comprising displaying a representation of the geometry within the local environment.

11. The method of claim 10, wherein the representation of the geometry is displayed in accordance with the local user moving to a location outside the geometry.

12. The method of claim 10, wherein the representation of the multi-user communication session is obfuscated to the local user in accordance with the local user moving to a location outside the geometry.

13. The method of claim 1, wherein the geometry comprises an area or volume.

14. The method of claim 13, wherein determining the area or volume comprises determining an intersection between the local constraint data and remote size constraint data,
wherein the local constraint data indicates first dimensions within the local environment available for presentation,
wherein the remote size constraint data indicates second dimensions within the remote environment available for presentation, and
wherein the intersection is determined based on the first dimensions and the second dimensions.

15. The method of claim 1, further comprising:
receiving an indication of a movement of a remote user of the second device in the remote environment;
receiving an indication that the movement of the remote user is affected by a physical object in the remote environment;
presenting, by the first device, a representation of the remote user in the representation of the multi-user communication session in accordance with the movement; and
presenting, by the first device, an indication of the physical object in the representation of the multi-user communication session in accordance with the indication that the movement of the remote user is affected by the physical object.

16. The method of claim 15, wherein receiving the indication that the movement of the remote user is affected by the physical object further comprises:
receiving, at the first device, data describing the physical object in the remote environment comprising a position of the physical object relative to a reference point,
wherein the indication of the physical object is presented in the representation of the multi-user communication session in accordance with the position of the physical object relative to the reference point.

17. A non-transitory computer readable medium comprising computer readable code executable by one of more processors to:
obtain, at a first device, local size constraint data associated with a local environment in which the first device is located;
obtain, at the first device, remote size constraint data associated with a remote environment in which a second device is located, wherein the first device and the second device are active in a multi-user communication session;
determine a geometry based on the local size constraint data and the remote size constraint data; and
present a representation of the multi-user communication session within the geometry.

18. The non-transitory computer readable medium of claim 17, wherein components of the multi-user communication session are presented within the geometry.

19. The non-transitory computer readable medium of claim 17, further comprising computer readable code to:
receive an indication that the remote user has moved to a location outside of the geometry; and
present an indication on a boundary of the geometry indicating the remote user moved to the location outside of the geometry.

20. A system, comprising:
one or more processors; and
one or more non-transitory computer readable media comprising computer readable code executable by the one of more processors to:
obtain, at a first device, local size constraint data associated with a local environment in which the first device is located;
obtain, at the first device, remote size constraint data associated with a remote environment in which a second device is located, wherein the first device and the second device are active in a multi-user communication session;
determine a geometry based on the local size constraint data and the remote size constraint data; and
present a representation of the multi-user communication session within the geometry.
